(19) United States
(12) Patent Application Publication
(10) Pub. No.: US 2011/0319137 A1
(43) Pub. Date: Dec. 29, 2011

(54) PORTABLE DEVICE

(75) Inventors: Yuto TAKAGI, Kanagawa (JP); Kuniharu Suzuki, Tokyo (JP)

(73) Assignee: SONY ERICSSON MOBILE COMMUNICATIONS JAPAN, INC., Minato-ku (JP)

(21) Appl. No.: 13/037,465

(22) Filed: Mar. 1, 2011

Related U.S. Application Data
(60) Provisional application No. 61/358,718, filed on Jun. 25, 2010.

(51) Int. Cl. H04B 1/38

(52) U.S. Cl. 455/566; 455/573

(57) ABSTRACT

A portable device including a casing, a photoelectric conversion section that converts light into electric power, a protective plate having light-transmitting property and protecting a light-receiving surface of the photoelectric conversion section, and a amount-of-received-light display section provided in a perimeter region of the protective plate, the amount-of-received-light display section made of a first paint that changes display color based on an amount of received light.

### CROSS-REFERENCE TO RELATED APPLICATION

This application claims the benefit of U.S. Provisional Application No. 61/358,718 filed Jun. 25, 2010, the entire contents of which is incorporated herein by reference.

### BACKGROUND OF THE INVENTION

1. Field of the Invention

The present invention relates to a portable device including a device that converts light into electric power, for example, a solar battery.

2. Description of the Related Art

With increasing interest in natural energy in recent years, more and more portable devices are mounted with a solar battery. If the output voltage of the solar battery is to be used directly as power supply voltage in this case, no power supply voltage can be obtained in environments where it is not possible to receive sunlight. Accordingly, in many cases it is common to provide a secondary battery and charge this secondary battery to produce power supply voltage.

A portable device is generally small in size, and so is the surface area of the light receiving surface of a solar battery mounted in the portable device. Hence, the amount of electric power the solar battery generates when mounted in the portable device is small. For this reason, when generating electric power by a solar battery, it is desirable to make the portable device receive as much light as possible. Therefore, it is very useful to inform the user of the amount of light striking the solar battery, as the power generation environment for the solar battery.

Accordingly, in the related art, as a portable telephone terminal mounted with a solar battery and a secondary battery, for example, the portable telephone terminal shown in FIG. 23 has been proposed. FIG. 23 shows a folding portable telephone terminal 1. A solar battery module 2 is provided in a surface 1a of the casing of the portable telephone terminal 1 which is exposed to the outside when the portable telephone terminal 1 is folded, in such a way that its light receiving surface 2a can receive incident light. The surface 1a provided with the solar battery module 2 is further provided with a charging environment display section 3 made of electronic paper, for example.

With the portable telephone terminal 1 according to the related art described above, the value of the output voltage of the solar battery module 2 varies with the amount of light incident on the solar battery module 2. Accordingly, the output voltage of the solar battery module 2 is monitored, and a display according to the output voltage is made on the charging environment display section 3. In the case of the portable telephone terminal 1 shown in FIG. 23, for example, a charging status mark 3a is displayed in three varied patterns: Optimal Charging (large amount of incident light), Charging (medium amount of incident light), and Charging Stop (small amount of incident light).

Also, Japanese Unexamined Patent Application Publication No. 7-122767 discloses a solar battery camera that performs a charging environment display. FIG. 24 shows the outward appearance of a camera 4 described in Japanese Unexamined Patent Application Publication No. 7-122767, as viewed from the back cover side of the camera 4. The camera 4 has a solar battery module 5 provided in a surface 4a on the back cover side in such a way that its light receiving surface 5a can receive incident light. The surface 4a provided with the solar battery module 5 is further provided with an amount-of-received-light display section 6.

The amount-of-received-light display section 6 is formed by a photochromic sheet 8 attached onto a reflecting member 7. In the case of Japanese Unexamined Patent Application Publication No. 7-122767, the photochromic sheet 8 is divided to a plurality of regions as shown in the drawing, each of which differs in sensitivity with respect to the amount of incident light. Portions of the photochromatic sheet 8 with high sensitivity develop color even with weak light, whereas portions of the photochromatic sheet 8 with low sensitivity do not develop color unless exposed to strong light. Therefore, in the case of the camera 4 according to Japanese Unexamined Patent Application Publication No. 7-122767, the user can learn the amount of incident light from the colorization state of each individual divided region of the photochromatic sheet 8.

Since the amount of electric power generated by a solar battery is small in the case of a portable device as described above, it should be avoided to use precious electric power for display of the charging environment. In addition, since the size of the portable device is small, it is also important to perform a display that is easy for the user to understand. Moreover, if a large surface area is used for display of the charging environment or the amount of received light, the surface area allocated to the light receiving surface of the solar battery becomes small, causing a decrease in the amount of generated electric power. Thus, it is also important to make efficient use of the casing's surface.

In the case of the portable telephone terminal 1 described above, however, since the charging environment display section 3 made of electronic paper is used for display of the charging environment, electric power is consumed for the display of the charging environment.

In contrast, in the case of the camera 4 according to Japanese Unexamined Patent Application Publication No. 7-122767, the photochromatic sheet 8 is used as the amount-of-received-light display section 6, so the problem of power consumption can be avoided. However, in the case of the camera 4 according to Japanese Unexamined Patent Application Publication No. 7-122767, an additional surface area separate from the solar battery module is necessary for providing the amount-of-received-light display section 6, leading to poor efficiency of use of the casing's surface. Consequently, the problem of reduced surface area allocated to the light-receiving surface of the solar battery and the resulting decrease in the amount of generated power remains.

### SUMMARY OF THE INVENTION

It is desirable to provide a portable device, which makes it possible to inform the user of the amount of light incident on photoelectric conversion component, without using precious electric power generated by a solar battery serving as the photoelectric conversion component, and by making efficient use of the casing's surface of the portable device.

According to an embodiment of the present invention, there is provided a portable device including: a casing; photoelectric conversion section configured to convert light into electric power, the photoelectric conversion section having a light receiving surface provided on a first surface side of the casing; a protective plate having light-transmitting property that protects the light receiving surface of the photoelectric conversion section on the one surface side of the casing; and an amount-of-received-light display section provided in a perimeter region of the protective plate which serves to hide a surrounding portion of the light receiving surface of the photoelectric conversion section, the amount-of-received-light display section being made of a first paint that changes display color in accordance with an amount of received light.

A protective plate having light transmitting property is provided to the front side of the light receiving surface of photoelectric conversion section such as a solar battery to protect the light receiving surface. In this case, terminal sections for connection to the outside or the like are provided around the light-receiving surface of the photoelectric conversion section. For this reason, the protective plate is formed with a size that allows it to protect even the connection terminal sections around the light receiving surface of the photoelectric conversion section, and the portion of the protective plate corresponding to the light receiving surface of the photoelectric conversion section is formed so as to have light transmitting property.

However, the perimeter region of the protective plate corresponding to the surrounding portion of the light receiving surface of the photoelectric conversion section normally undergoes such processing as being filled in with black to hide the connection terminal portions or the like in the surrounding portion, and thus becomes a so-called dead space.

According to an embodiment of the present invention, an amount-of-received-light display section made of a first paint that changes display color in accordance with the amount of received light is provided in the perimeter region of this protective plate corresponding to the surrounding portion of the light receiving surface of the photoelectric conversion section. That is, according to an embodiment of the present invention, the amount-of-received-light display section is provided in the perimeter region that is an unused dead space in the related art, thereby making effective use of this perimeter region.

Further, according to an embodiment of the present invention, the amount-of-received-light display section that informs the user of the amount of received light uses the first paint that changes display color in accordance with the amount of received light. Therefore, unlike electronic paper, no power supply is necessary, and the problem of power consumption does not arise.

### BRIEF DESCRIPTION OF THE DRAWINGS

FIGS. 1A to 1C are views for explaining the configuration of the main portion of a portable device according to a first embodiment of the present invention; FIGS. 2A and 2B are views for explaining the configuration of the main portion of the portable device according to the first embodiment of the present invention;

FIG. 3 is a characteristic chart for explaining materials for a protective plate used in the portable device according to the first embodiment of the present invention;

FIGS. 4A to 4F are views used for explaining the configuration of the protective plate used in the portable device according to the first embodiment of the present invention;

FIG. 5 is an exploded perspective view for explaining the configuration of the main portion of the portable device according to the first embodiment of the present invention;

FIG. 6 is a view showing an exemplary circuit configuration of the portable device according to the first embodiment of the present invention;

FIGS. 7A and 7B are views for explaining the configuration of the main portion of a portable device according to a second embodiment of the present invention;

FIG. 8 is a view for explaining the configuration of the main portion of the portable device according to the second embodiment of the present invention;

FIG. 9 is a view for explaining the configuration of the main portion of the portable device according to the second embodiment of the present invention;

FIG. 10 is a view for explaining the configuration of the main portion of a portable device according to a third embodiment of the present invention;

FIG. 11 is a view for explaining the configuration of the main portion of the portable device according to the third embodiment of the present invention;

FIG. 12 is a view for explaining the configuration of the main portion of the portable device according to the third embodiment of the present invention;

FIGS. 13A and 13B are views for explaining the configuration of the main portion of a portable device according to a fourth embodiment of the present invention;

FIG. 14 is a diagram for explaining operation of the main portion of the portable device according to the fourth embodiment of the present invention;

FIGS. 15A to 15F are views used for explaining the configuration of a protective plate used in the portable device according to the fourth embodiment of the present invention;

FIGS. 16A and 16B are views for explaining the configuration of the main portion of a portable device according to a fifth embodiment of the present invention;

FIGS. 17A to 17C are views for explaining the configuration of the main portion of a portable device according to a sixth embodiment of the present invention;

FIG. 18 is a view for explaining a partial modification of the portable device according to the sixth embodiment of the present invention;

FIGS. 19A to 19F are views for explaining a first example of a portable device according to a seventh embodiment of the present invention;

FIGS. 20A to 20F are views for explaining a second example of the portable device according to the seventh embodiment of the present invention;

FIG. 21 is a view for explaining the main portion of a portable device according to another embodiment of the present invention;

FIG. 22 is a view for explaining the main portion of a portable device according to another embodiment of the present invention;

FIG. 23 is a view for explaining an example of a portable device according to the related art; and

FIG. 24 is a view for explaining an example of a portable device according to the related art.

### DESCRIPTION OF THE PREFERRED EMBODIMENTS

Hereinbelow, a portable device according to each of several embodiments of the present invention will be described with reference to the drawings, with the case where the portable device is a portable telephone terminal taken as an example.

### First Embodiment

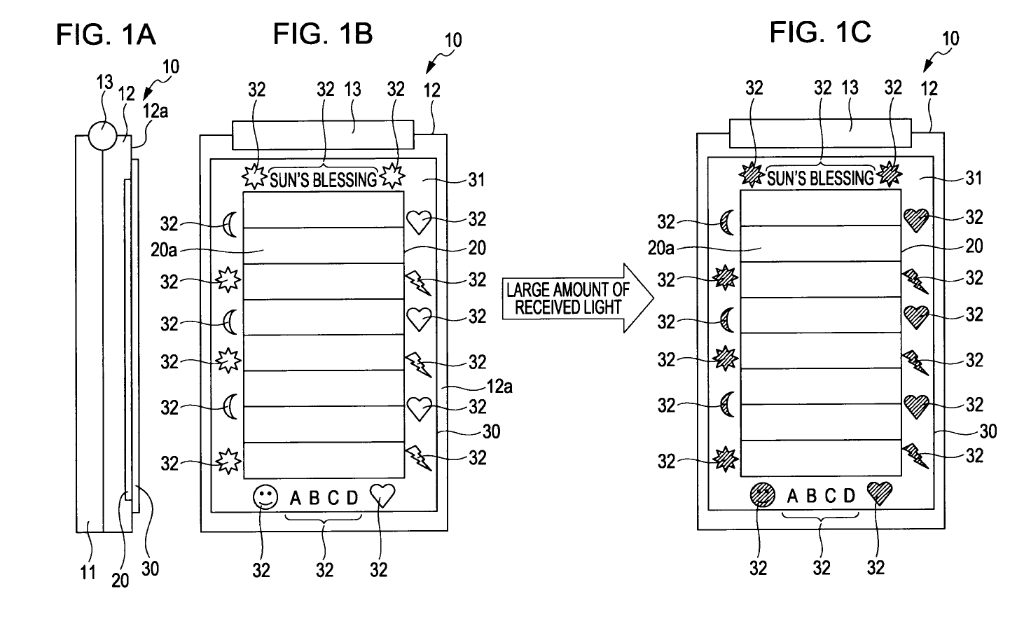

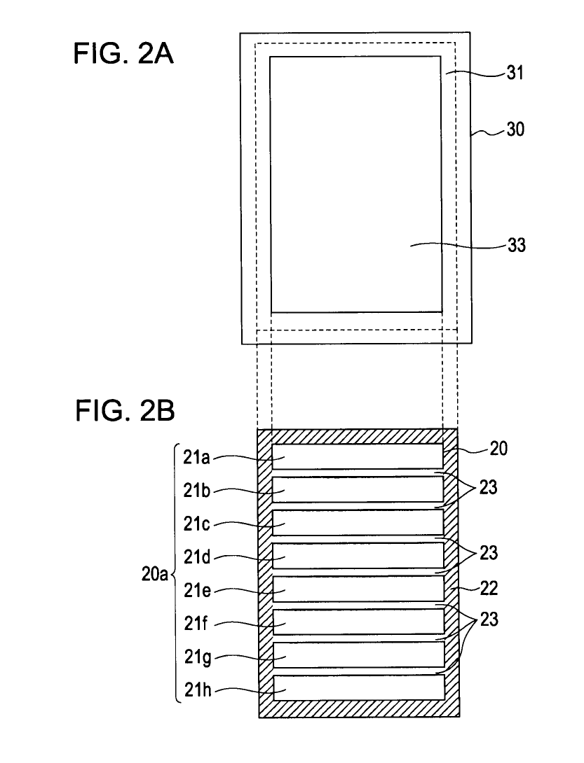

FIGS. 1A to 1C are views for explaining the outward appearance of a portable telephone terminal 10 as a portable device according to a first embodiment of the present invention. The portable telephone terminal 10 in the case of FIGS. 1A to 1C is of a folding type, and FIG. 1A is its side view and FIG. 1B is its plan view. Also, FIG. 1C is a view used for explaining how the state of an amount-of-received-light display section changes when there is a large amount of light incident on the portable telephone terminal 10.

As shown in FIG. 1A, the portable telephone terminal 10 is configured as a folding one having a lower housing 11 and an upper housing 12 rotatably coupled together by a hinge section 13. The upper casing 12 is provided with a solar battery module 20. As shown in FIG. 1B, in the solar battery module 20, its light receiving surface 20a is provided in a surface 12a that is a rectangular upper flat surface of the upper casing 12 exposed to the outside in the state when the portable telephone terminal 10 is folded, in such a way that the light receiving surface 20a can receive incident light.

A protective plate 30 made of a transparent material that transmits light is provided on the front side of the light receiving surface 20a of the solar battery module 20.

In this case, as shown in FIG. 2B, the solar battery module 20 is made up of a plurality of solar cells, which in this example are eight solar cells 21a, 21b, 21c, . . . , 21h connected in series. The respective light receiving surfaces of the solar cells 21a, 21b, 21c, . . . , 21h are so provided as to be capable of receiving incident light through the protective plate 30.

It should be noted that the light receiving surface 20a of the solar battery module 20 is made up of a set of the respective light receiving surfaces of the solar cells 21a, 21b, 21c, . . . , 21h. Seal sections 23 not contributing to photoelectric conversion are created between the plurality of solar cells 21a, 21b, 21c, . . . , 21h.

As shown in FIG. 2B, the solar battery module 20 has a perimeter frame section 22 around its light receiving surface 20a. The perimeter frame section 22 includes connecting sections for connecting the plurality of solar cells 21a, 21b, 21c, . . . , 21h in series, lead sections for connection to a printed circuit board, the main seal section of an outer frame unique to a dye-sensitized solar battery, and the like. For the sake of convenience, in FIG. 2B, the perimeter frame section 22 is indicated by oblique lines.

As shown in FIG. 2A, the protective plate 30 is formed in a rectangular shape larger than the solar battery module 20. A perimeter region portion 31 of the protective plate 30 indicated by oblique lines in FIG. 2A is used as a region for covering the perimeter frame section 22 of the solar battery module 20 to make the perimeter frame section 22 invisible from the outside.

In the case of this example, a central region portion 33 of the protective plate 30 surrounded by the perimeter region portion 31 has substantially the same shape and substantially the same surface area as the light receiving surface 20a of the solar battery module 20 surrounded by the perimeter frame section 22.

In the related art, a hiding section that hides the perimeter frame section 22 of the solar battery module 20 is formed in the perimeter region portion of the protective plate by coating, printing, or the like of black paint or the like. In contrast, the perimeter region portion 31 of the protective plate 30 according to this embodiment is provided with not only a hiding section used for the hiding purpose but also power-generation-environment display sections 32 for the solar battery which perform a display in accordance with the amount of received light. The power-generation-environment display sections 32 each constitute an amount-of-received-light display section.

That is, in this embodiment, while the perimeter region portion 31 of the protective plate 30 is coated or printed with black paint for the hiding purpose, black paint is not coated or printed onto regions that serve as the power-generation-environment display sections. Then, photochromic paint, which changes display color in accordance with the amount of received light, is coated or printed onto the regions not coated or printed with black paint, thereby forming the power-generation-environment display sections 32. As the photochromatic paint, for example, Sunny Color (product name) manufactured by Kirokusozai Sogo Kenkyusho Co., Ltd. is used.

In FIG. 1B, design display regions indicated as sun marks, moon marks, heart marks, thunder marks, letters, and the like inside the perimeter region portion 31 of the protective plate 30 are the power-generation-environment display sections 32. As in this example, the power-generation-environment display sections 32 can be represented as the designs of various symbols, marks, or letters, and a plurality of such power-generation-environment display sections 32 are formed inside the perimeter region portion 31. Of course, a plurality of power-generation-environment display sections 32 may not be necessarily be formed in the perimeter region portion 31 but only one power-generation-environment display section 32 may be formed.

In this embodiment, as will be described later, the photochromic paint forming the power-generation-environment display sections 32 is coated or printed onto the back surface opposite to the light incidence surface of the protective plate 30. Although the photochromic paint may be formed on the light incidence surface of the protective plate 30, in that case, there is a problem in that the photochromic paint forming the power-generation-environment display sections 32 is directly exposed to the outside, which may make the graininess of the paint conspicuous, and the paint becomes prone to damage due to scratching or the like.

Accordingly, in this example, by applying the photochromic paint forming the power-generation-environment display sections 32 to the back surface side of the protective plate 30 by coating or printing, the perimeter region portion 31 of the protective plate 30 serves to maintain the aesthetic appearance of the power-generation-environment display sections 32, and also serves as a protection against scratching or the like.

In the case where the power-generation-environment display sections 32 are provided on the back surface side of the protective plate 30 in this way, it is necessary to determine the material of the protective plate 30 by taking into consideration the fact that photochromic paint is particularly responsive to ultraviolet rays of light.

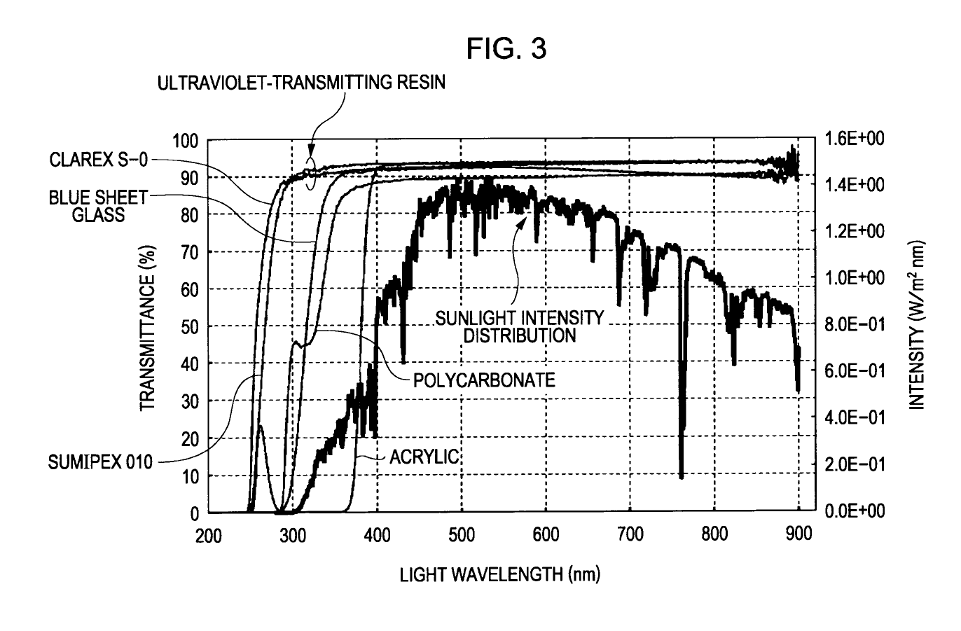

FIG. 3 shows an example of spectral transmittances measured with respect to transparent plates of various materials. Ultraviolet rays are rays of light (electromagnetic waves) with wavelengths shorter than those of visible rays of light, but longer than x-rays, in the range of 1 nanometer to 400 nanometers. As shown in FIG. 3, a transparent plate made of acrylic resin has a light transmission wavelength of 380 nanometers or more, and transmits hardly any ultraviolet rays.

Also, since polycarbonate or blue sheet glass has a light transmission wavelength of 320 nanometers or more and transmits ultraviolet rays, polycarbonate or blue sheet glass can be used as the protective plate 30. However, the wavelength at and above which polycarbonate or blue sheet glass uniformly transmits 90 percent or more of light is 350 nanometers, and hence the coloring property of the photochromic paint deteriorates.

In contrast, for example, ultraviolet-transmitting resin such as Clarex S-0 (product name) manufactured by Nitto Jushi Kogyo Co., Ltd. or SUMIPEX 010 (product name) manufactured by Sumitomo Chemical Co., Ltd. uniformly transmits 90 percent or more of light in the range of about 300 nanometers to 1200 nanometers. Therefore, the coloring property of the photochromic paint becomes favorable in comparison to using polycarbonate or blue sheet glass, making such ultraviolet-transmitting resin suitable for the protective plate 30 according to this embodiment.

For the above reasons, in this embodiment, an ultraviolet-transmitting member made of ultraviolet-transmitting resin or the like is used as the protective plate 30. This embodiment uses, for example, a transparent plate made of ultraviolet-transmitting resin such as Clarex S-0 (product name) manufactured by Kuraray Co., Ltd. or SUMIPEX 010 (product name) manufactured by Sumitomo Chemical Co., Ltd.

Therefore, in this embodiment, the photochromic paint forming the power-generation-environment display sections 32 can receive ultraviolet rays passing through the protective plate 30 in a favorable manner. It should be noted that the material of the protective plate 30 is not limited to the transparent plate made of each of the ultraviolet-transmitting resins in the example shown in FIG. 3. It is further desirable if it is possible to use a transparent plate made of ultraviolet-transmitting resin that transmits 90 percent or more of light at a light transmission wavelength of about 250 nanometers to 1200 nanometers.

### <Method of Forming Power-Generation-Environment Display Sections 32 in Protective Plate 30>

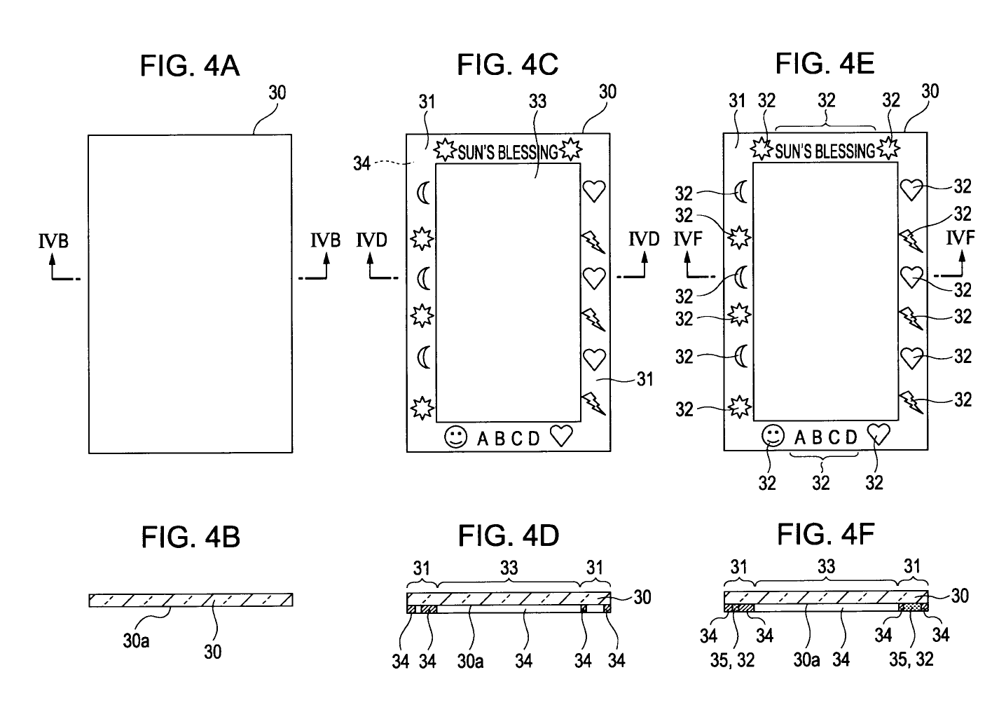

Referring to FIGS. 4A to 4F, a description will be given of an example of the method of forming the power-generation-environment display sections 32 in the perimeter region portion 31 of the protective plate 30.

First, ultraviolet-transmitting resin that forms the protective plate 30 is selected. In this example, for example, Clarex S-0 (product name) manufactured by Kuraray Co., Ltd. is used. FIG. 4A is a plan view of the protective plate 30, and FIG. 4B is a cross-sectional view taken along the line IVB-IVB of FIG. 4A. As shown in FIGS. 4A and 4B, the protective plate 30 in this example is made up of a single transparent plate of ultraviolet-transmitting resin, including the region that is to become the perimeter region portion 31.

Next, as shown in FIG. 4C and FIG. 4D that is a IVD-IVD cross-sectional view of FIG. 4C, in this case, hiding paint is applied by screen printing (pattern printing) in this example to a region on the back surface 30a side of the protective plate 30 corresponding to the perimeter region portion 31, except for the regions of the power-generation-environment display sections 32 formed by design display sections formed as designs of symbols, marks, or letters, thereby forming a hiding-paint-applied section 34. As the hiding paint, black paint is used in this case. It should be noted that it suffices for the hiding-paint-applied section 34 to be able to hide the perimeter frame section 22 of the solar battery module 20 provided on the back surface 30a side of the protective plate 30 so as to be invisible from the outside. Accordingly, the paint to be applied is not limited to a black paint, but a paint of any color that can provide opacity may be used.

Next, as shown in FIG. 4E and FIG. 4F that is a IVF-IVF cross-sectional view of FIG. 4E, in a region on the back surface 30a side of the protective plate 30 corresponding to the perimeter region portion 31, photochromic paint is applied by screen printing (pattern printing) in this example to regions not applied with the hiding paint and where the power-generation-environment display sections 32 are to be formed, thereby forming photochromic-paint-applied sections 35. The photochromic-paint-applied sections 35 form the power-generation-environment display sections 32.

In this way, on the back surface 30a side of the protective plate 30, in the perimeter region portion 31 of the protective plate 30, a hiding section that hides the perimeter frame section 22 of the solar battery module 20 is formed by the hiding-paint-applied section 34, and also the plurality of power-generation-environment display sections 32 formed by the photochromic-paint-applied sections 35 are formed.

While in the above example the photochromic-paint-applied sections 35 are formed after the hiding-paint-applied section 34 is formed, the hiding-paint-applied section 34 may be formed after the photochromic-paint-applied sections 35 are formed.

The photochromic-paint-applied sections 35, that is, the power-generation-environment display sections 32 normally take on a white color in the state when a predetermined amount or more of light is not received. Then, once the predetermined amount or more of light is received, as indicated by diagonal lines in FIG. 1C, the photochromic-paint-applied sections 35, that is, the power-generation-environment display sections 32 change to a predetermined color from white, and the density of the display color becomes one corresponding to the amount of received light.

For example, in the case where the photochromic paint is a so-called red-based paint, as the amount of received light increases, the display color of the photochromic-paint-applied sections 35, that is, the power-generation-environment display sections 32 changes from white to pink and then to red. Also, in the case where the photochromic paint is a so-called blue-based paint, as the amount of received light increases, the display color of the photochromic-paint-applied sections 35, that is, the power-generation-environment display sections 32 changes from white to pale blue and then to dark blue.

As described above, as the photochromic paint, only one of red-based paint and blue-based paint may be used as it is. Also, the coloring sensitivity of the photochromic paint may be adjusted by mixing, for example, an acrylic solvent into the photochromic paint to reduce its coloring sensitivity with respect to the amount of received light. That is, the amount of the acrylic solvent to be mixed may be adjusted so that the power-generation-environment display sections 32 remain white until a predetermined amount of light is received, and start to develop color when the amount of received light becomes equal to or more than the predetermined amount.

Also, the coloring sensitivity of the photochromic paint may be adjusted by forming thin films such as films with a predetermined ultraviolet transmittance on at least the photochromic-paint-applied sections 35 (power-generation-environment display sections 32) of the perimeter region portion 31, and adjusting the number of such films or their film thickness.

The plurality of power-generation-environment display sections 32 provided inside the perimeter region portion 31 of the protective plate 30 may include both those made of red-based photochromic paint and those made of blue-based photochromic paint. Generally, red-based photochromic paint has good coloring property with respect to the amount of received light and, conversely, blue-based photochromic paint has poor coloring property with respect to the amount of received light.

Accordingly, if both the power-generation-environment display sections 32 applied with red-based photochromic paint and the power-generation-environment display sections 32 applied with blue-based photochromic paint exist in the perimeter region portion 31 of the protective plate 30, the amount of received light can be judged as follows from both the power-generation-environment display sections 32.

In a state when the power-generation-environment display sections 32 applied with red-based photochromic paint have started to develop color but the power-generation-environment display sections 32 applied with blue-based photochromic paint have not developed color, it can be judged that the amount of received light is relatively small, and that the power generation environment is not satisfactory for the solar battery module 20. If both the power-generation-environment display sections 32 applied with red-based photochromic paint and the power-generation-environment display sections 32 applied with blue-based photochromic paint have started to develop color, it can be judged that the power generation environment is relatively satisfactory for the solar battery module 20.

The paint in the photochromic-paint-applied sections 35 forming the power-generation-environment display sections 32 may be a mixture of red-based photochromic paint and blue-based photochromic paint. In that case, when the amount of received light is relatively small and the power generation environment is not satisfactory for the solar battery module 20, the power-generation-environment display sections 32 display red color. Then, as the amount of received light increases, the blue-based paint develops color, so the display color of the power-generation-environment display sections 32 becomes purple color that is the mixed color of the two colors, and as the amount of light further increases, the purple color becomes darker.

The display color of the power-generation-environment display sections 32 can be changed to an arbitrary predetermined color by mixing a pigment into the photochromic paint. In that case, when the amount of received light increases, the resulting color will be the mixed color of the pigment's color and the display color of the red-based or blue-based photochromic paint.

As described above, in the state when the solar battery module 20 is mounted to the upper casing 12 with its light receiving surface 20a protected by the protective plate 30, the amount of light received by the solar battery module 20 is displayed by the display color of the photochromic-paint-applied sections 35 forming the power-generation-environment display sections 32 provided in the perimeter region portion 31 of the protective plate 30, thereby informing the user of the amount of received light.

Therefore, the power-generation-environment display sections 32 formed by the photochromic-paint-applied sections 35 in the perimeter region portion 31 of the protective plate 30 inform the user of the amount of light received by the solar battery module 20 at that time, through a change in their display color. Thus, by looking at the display color of the power-generation-environment display sections 32, the user is able to judge, at a glance, whether or not the amount of light received at that time is appropriate for power generation by the solar battery module 20.

### <Mounting of Solar Battery Module 20 and Protective Plate 30 to Portable Telephone Terminal 10>

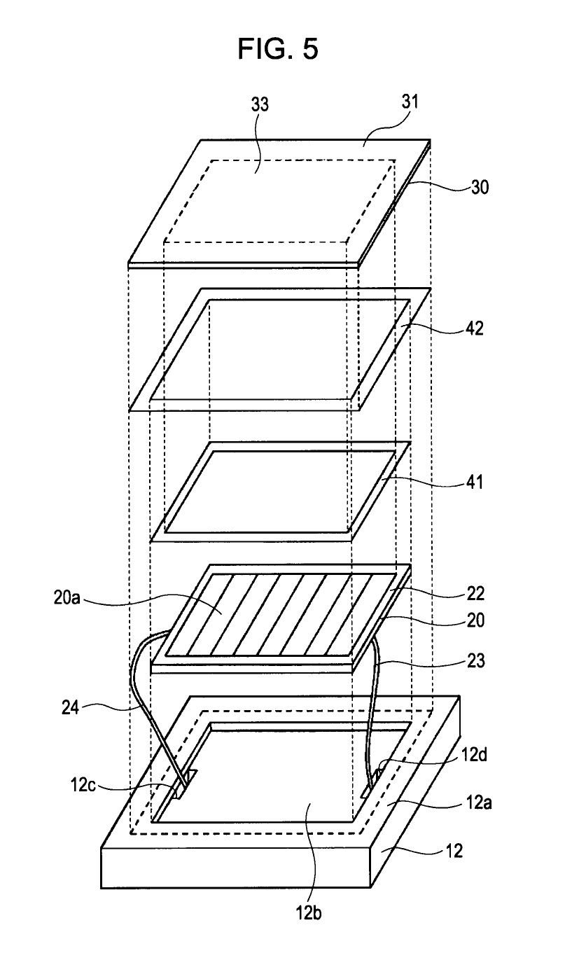

FIG. 5 is an exploded perspective view for explaining how the solar battery module 20 and the protective plate 30 are mounted to the upper casing 12 of the portable telephone terminal 10.

The surface 12a of the upper casing 12 of the portable telephone terminal 10 is provided with a recess 12b in which the solar battery module 20 is fitted and accommodated. Through-holes 12c and 12d extending through the upper casing 12 are provided at the longitudinal ends of the recess 12b. Lead sections 23 and 24 led out from the longitudinal ends of the solar battery module 20 are led to a flexible board (not shown) in the interior of the upper casing 12 via the through-holes 12d and 12c, respectively, and connected to this flexible board.

It should be noted that when the solar battery module 20 is fitted and accommodated in the recess 12b, the perimeter frame section 22 and light receiving surface 20a of the solar battery module 20, and the surface 12a of the upper casing 12 become substantially flush with each other.

A cushioning material 41 for shock absorption, which is formed in the same frame-like shape as the perimeter frame section 22 and made of, for example, a foamed PET sheet with a thickness of about 0.3 mm, for example, is provided on the perimeter frame section 22 of the solar battery module 20.

A double-faced tape 42 is provided around the recess 12b in which the solar battery module 20 is fitted and accommodated, as an example of an adhesion member for adhering the protective plate 30 to the upper casing 12 at its perimeter region portion 31. It should be noted that the double-faced tape 42 has a frame-like shape, and the cushioning material 41 also having a frame-like shape is arranged within the frame. In this case, the perimeter region portion 31 of the protective plate 30 has a shape exactly conforming to that of the frame-shaped portion formed by both the double-faced tape 42 and the cushioning material 41.

Although not shown here, as described above with reference to FIGS. 4A to 4F, in the region on the back surface side of the protective plate 30 corresponding to the perimeter region portion 31, the hiding-paint-applied section 34 is formed, and also the power-generation-environment display sections 32 formed by the photochromic-paint-applied sections 35 are formed.

Then, the protective plate 30 is attached with the double-faced tape 42 onto the surface 12a of the upper casing 12, in the state with its perimeter region portion 31 exactly conforming to the frame-shaped portion formed by both the double-faced tape 42 and the cushioning material 41. Therefore, at this time, the central region portion 33 of the protective plate 30 is located exactly above the light receiving surface 20a of the solar battery module 20.

The attachment of the protective plate 30 onto the upper casing 12 causes the solar battery module 20 fitted and accommodated in the recess 12b to be fitted onto the upper casing 12 via the cushioning material 41. Also, the light receiving surface 20a of the solar battery module 20 is protected by the protective plate 30, and the perimeter frame section 22 of the solar battery module 20 is hid by the hiding-paint-applied section 34 and the power-generation-environment display sections 32 formed by the photochromic-paint-applied sections 35, which are formed in the perimeter region portion 31 of the protective plate 30.

<Exemplary Circuit Configuration of Portable Telephone Terminal 10 according to Embodiment>

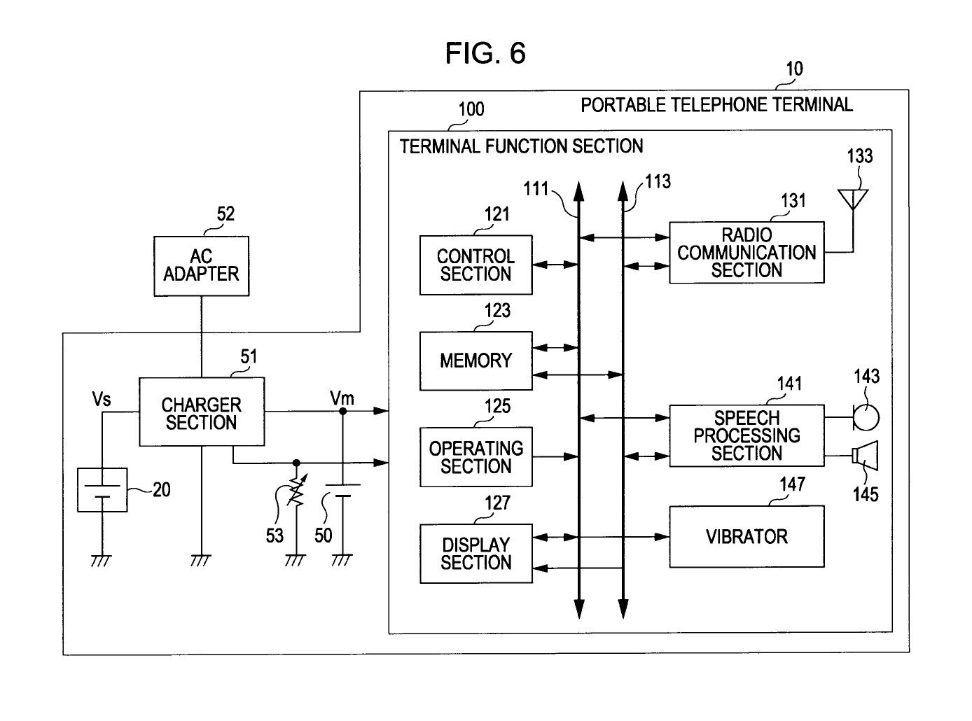

Next, an exemplary circuit configuration of the portable telephone terminal 10 according to this embodiment will be described with reference to FIG. 6.

If the output voltage of the solar battery module 20 is to be used directly as power supply voltage, no power supply voltage can be obtained in environments where it is not possible to receive sunlight. Accordingly, in many cases it is common to provide a secondary battery and charge this secondary battery to produce power supply voltage. The portable telephone terminal 10 according to this embodiment includes a secondary battery 50 made of a lithium ion battery, for example, and also includes a charger section 51. The charger section 51 charges the secondary battery 50 by the generated output of the solar battery module 20.

The charger section 51 is configured to charge the secondary batter 50 not only by the power generation output from the solar battery module 20 but also by the commercial AC voltage. For this reason, an AC adapter 52 is connected to the charger section 51. When the AC adapter 52 is connected to a commercial socket (not shown), the charger section 51 is configured to charge the secondary battery 50 by a DC current obtained by rectifying the commercial AC current by the AC adapter 52, without using the generated output of the solar battery module 20.

Then, the output voltage Vm of the secondary battery 50 is supplied to a terminal function section 100 of the portable telephone terminal 10 as its power supply voltage. The terminal function section 100 includes a control section 121, a memory 123, an operating section 125, a display section 127, a radio communication section 131, a speech processing section 141, a vibrator 147, and the like connected to a system bus made up of a control bus 111 and a data bus 113.

The control section 121 includes a microcomputer, and controls the portable telephone terminal 10 as a whole. The memory 123 retains data necessary for the portable telephone terminal 10, in addition to software programs. The operating section 125 is formed by a ten key or other such function key.

The display section 127 includes a display formed by, for example, an LCD (Liquid Crystal Display), and performs various displays. The radio communication section 131 performs communication through a portable telephone network via an antenna 133. The speech processing section 141 sends a user's speech signal from a microphone 143 to the radio communication section 131 as a sending speech signal, and performs audio reproduction of a receiving speech signal, which is received from the portable telephone network via the radio communication section 131, from a loudspeaker 145. The vibrator 147 vibrates the casing in accordance with control by the control section 121 when there is an incoming call at the radio communication section 131, thereby notifying the incoming call.

The configuration and operation of the terminal function section 100 described above are the same as those of the terminal function section of an ordinary portable telephone terminal.

The charger section 51 regards the secondary battery 50 to be fully charged when the charging voltage Vm of the secondary battery 50 reaches a predetermined value, and stops charging.

Characteristically, a lithium ion battery deteriorates severely when held at high potential under high temperature environment. Thus, when the temperature of the secondary battery 50 becomes high, the charger section 51 stops charging, or discharges the secondary battery 50 to lower its output potential.

Accordingly, in this embodiment, a thermo-sensitive element, for example, a thermistor 53 whose resistance varies with temperature is provided near the secondary battery 50, and the temperature of the secondary battery 50 is estimated from the voltage across the thermistor 53. Then, upon detecting that the secondary battery 50 is at high potential under high temperature environment from the voltage across the thermistor 53 and the output voltage Vm of the secondary battery 50, the charger section 51 stops charging, and discharges the secondary battery 50 as necessary to lower the output voltage Vm of the secondary battery 50.

Although not shown, in this example, the control section 121 monitors the output voltage Vm of the secondary battery 50, and the voltage across the thermistor 53, and upon reaching a state where the secondary battery 50 is brought to a high potential under high temperature environment and thus the charger section 51 is to stop charging, the control section 121 displays information to that effect on the display screen of the display section 127 to call user's attention.

As described above, in this embodiment, the power-generation-environment display sections 32 formed by the photochromic-paint-applied sections 35 are provided in the perimeter region portion 31 of the protective plate 30, and the user is informed of the amount of light received by the light receiving surface 20a of the solar battery module 20, on the basis of a change in the display color of the power-generation-environment display sections 32. Therefore, the power-generation-environment display sections 32 according to this embodiment provide a remarkable advantage that no power supply is necessary unlike in the case of electronic paper according to the related art, and the problem of power consumption does not arise.

Since the power-generation-environment display sections 32 are provided in the perimeter region portion 31, which hides the frame portion around the light receiving surface 20a of the solar battery module 20, of the protective plate 30 for protecting the light receiving surface 20a of the solar battery module 20, no additional space is particularly necessary for the power-generation-environment display sections 32. Therefore, even when the power-generation-environment display sections 32 are provided in the same casing surface as the solar battery module 20, the space allocated to the light receiving surface of the solar battery module 20 is not reduced, thus making it possible to avoid a situation where the amount of power generation decreases.

Furthermore, since the power-generation-environment display sections 32 are provided in the perimeter region portion 31 that hides the frame portion around the light receiving surface 20a of the solar battery module 20, the power-generation-environment display sections 32 are provided in the same surface as the solar battery module 20, and are located in close proximity to the light receiving surface 20a of the solar battery module 20, thereby making it possible to more accurately display the intensity of light incident on the light receiving surface of the solar battery module 20.

### <Modifications of First Embodiment>

The first embodiment described above is directed to the case of a portable telephone terminal, and it is assumed that the solar battery module 20 is used to charge the secondary battery 50. However, of course, the present invention is also applicable to portable devices other than a portable telephone terminal, and is also applicable to portable devices that do not have a secondary battery and use the output voltage of the solar battery module 20 as it is as power supply voltage.

The foregoing description is directed to the case in which, for the purpose of putting an emphasis on design property, the power-generation-environment display sections 32 formed by the photochromic-paint-applied sections 35 are applied or printed onto the perimeter region portion 31 of the protective plate 30 as predetermined design patterns in combination with the hiding-paint-applied section 34. However, it is also possible not to form the hiding-paint-applied section 34, and coat or print the photochromic paint onto the entire perimeter region portion 31 of the protective plate 30 so that the entire perimeter region portion 31 of the protective plate 30 serves as the power-generation-environment display sections 32.

The foregoing description is directed to the case in which the photochromic paint is applied after the hiding paint is applied to the perimeter region portion 31. However, it is also possible to apply the hiding paint after applying the photochromic paint to the perimeter region portion 31. In that case, the hiding paint may be applied to the entire perimeter region portion 31, including portions above the photochromic paint.

### Second Embodiment

A portable device according to a second embodiment concerns a contrivance by which, in the case where a secondary battery is provided and the secondary battery is charged by the output voltage of a solar battery module and commercial AC voltage, not only display of the power generation environment of the solar battery module (display of the amount of received light) but also display of the charging environment of the secondary battery (display of the battery temperature of the secondary battery) can be performed without power consumption and without unnecessarily wasting display space.

As described above, a lithium ion battery used as a secondary battery deteriorates severely when held at high output potential under high temperature environment. Thus, it is desirable that the temperature of the secondary battery during charging be 60° C. or lower, for example, and it is desirable to stop charging or lower the charging voltage when this temperature is exceeded. For this reason, to create an optimal power generation/charging environment, it is important to inform the user of the temperature of the secondary battery.

Incidentally, in the portable telephone terminal 10 according to the first embodiment described above, as described above with reference to the exemplary circuit in FIG. 6, upon reaching a state where the secondary battery 50 is brought to a high potential under high temperature environment and thus the charger section 51 is to stop charging, the control section 121 displays information to that effect on the display screen of the display section 127 to call user's attention.

In the case where information indicating that the secondary battery 50 is under high temperature environment is displayed on the display screen in this way, there is a problem in that precious electric power of the secondary battery is consumed.

In the case of a portable device mounted with a solar battery module, generally, the casing surface in which the display screen is provided and the casing surface in which the light receiving surface of the solar battery module is provided are different. Therefore, with the method of displaying information indicating that the secondary battery 50 is under high temperature environment on the display screen as in the case of the example in FIG. 6 according to the first embodiment, to check the temperature environment of the secondary battery 50, it is necessary for the user to change the position of the portable device so that the user can view the display screen, which is cumbersome.

Incidentally, in order to effectively prevent deterioration of the secondary battery 50 due to the secondary battery 50 being brought to a high potential under high temperature environment, it is preferable to stop charging when the secondary battery 50 is placed under high temperature environment, even when the secondary battery is not brought to a high potential. This is because if charging is stopped after the second battery 50 is brought to a high potential under high temperature environment, deterioration of the secondary battery has already occurred at that point.

Accordingly, while the second battery is being charged by the generated voltage of the solar battery module or commercial AC voltage, if it is possible to appropriately inform the user of the fact that the secondary battery 50 is under high temperature environment, this proves very useful. This is because if the user acknowledges such an inappropriate charging environment, the user can take appropriate measures to avoid such a charging environment, for example, stopping charging, or if the ambient environment of the portable device is a high temperature environment, moving the portable device from that environment to another environment.

In view of the above, the portable device according to the second embodiment is configured to perform display of the power generation environment in the same way as in the first embodiment, and also perform display of the charging environment as to whether the second battery is at a high temperature or not, while avoiding power consumption.

Hereinbelow, as an example of the portable device according to the second embodiment, a description will be given of the case of a portable telephone terminal with reference to the drawings. It should be noted that portions that are the same as those in the first embodiment are denoted by the same symbols, and detailed description thereof is omitted.

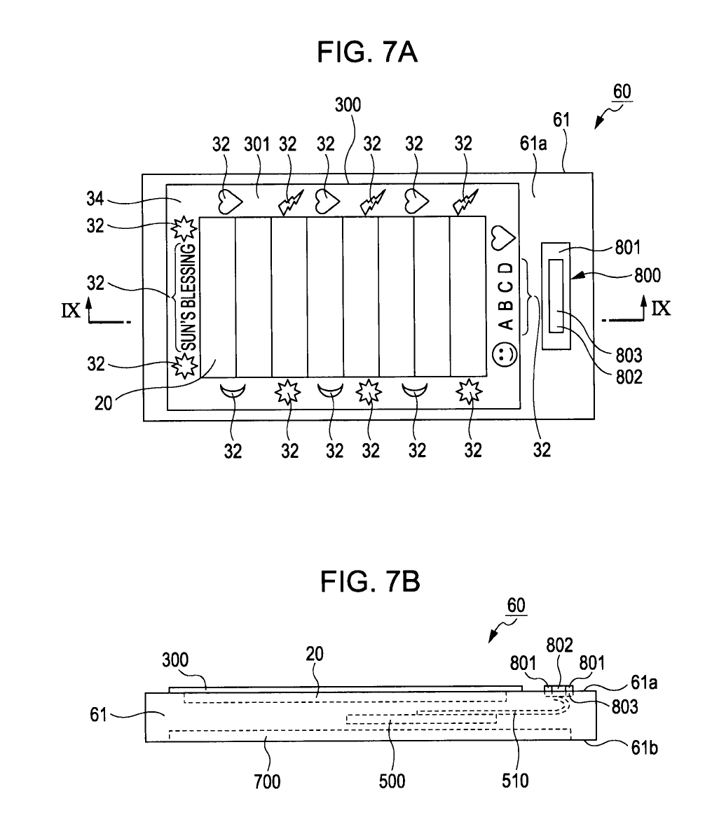

FIGS. 7A and 7B show the outward appearance of a portable telephone terminal 60 to which the second embodiment is applied. The portable telephone terminal 60 in this example is of a non-folding type (so-called straight type). FIG. 7A is a plan view of the portable telephone terminal 60, and FIG. 7B is a side view thereof.

The portable telephone terminal 60 includes a casing 61 having a flat rectangular parallelepiped shape. On one rectangular flat surface 61a side of the casing 61, the solar battery module 20 is provided in such a way that its light receiving surface can receive light from the outside via a protective plate 300. On the rectangular flat surface 61b side of the casing 61 opposite to the rectangular flat surface 61a, a display screen 700 formed by, for example, an LCD is provided.

The configuration for mounting the solar battery module 20 and the protective plate 300 to the casing 61 is the same as the configuration for mounting the solar battery module 20 and the protective plate 30 to the upper casing 12 according to the first embodiment described above with reference to FIG. 5.

Also, as in the first embodiment, a perimeter region portion 301 of the protective plate 300 serves as a hiding region for the perimeter frame portion of the solar battery module 20. That is, in the same manner as described above with reference to FIGS. 4A to 4F in the first embodiment, the hiding-paint-applied section 34 formed by, for example, black paint, and the power-generation-environment display sections 32 formed by the photochromic-paint-applied sections 35 are formed.

The portable telephone terminal 600 according to this embodiment includes a secondary battery 500 formed by, for example, a lithium ion battery provided in the interior of the casing.

Also, a charging environment display section 800 for displaying the temperature of the secondary pattern 500 is further provided in the rectangular flat surface 61a of the casing 61 of the portable telephone terminal 60 according to this embodiment which is located on the light receiving surface side of the solar battery module 20.

The charging environment display section 800 includes a heat insulating section 801 made of, for example, rubber, a transparent plate 802, and a thermochromic-paint-applied section 803 that is formed by coating or printing thermochromic paint onto the back surface side (side not exposed to the outside) of the transparent plate 802. The thermochromic paint is a paint that changes display color with heat. For example, Thermal Color (product name) manufactured by Kirokusozai Sogo Kenkyusho Co., Ltd. is used.

The heat insulating section 801 is provided so as to surround the transparent plate 802, so that the temperature of the casing 61 is not directly transmitted to the thermochromic-paint-applied section 803. It should be noted that the material of the heat insulating section 801 is not limited to rubber, but may be any material with low heat conductivity such as resin.

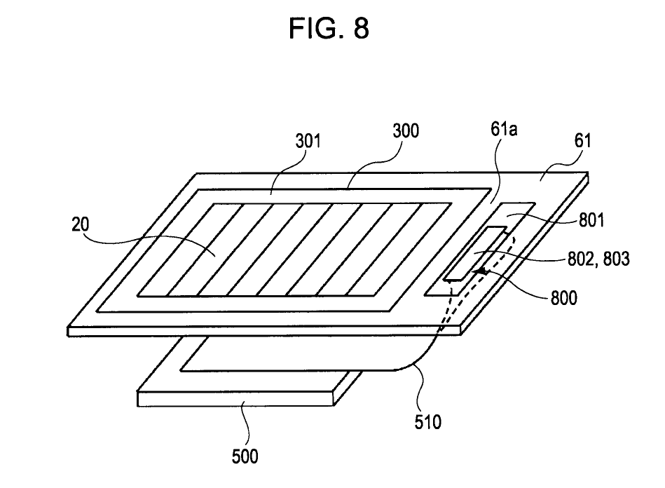

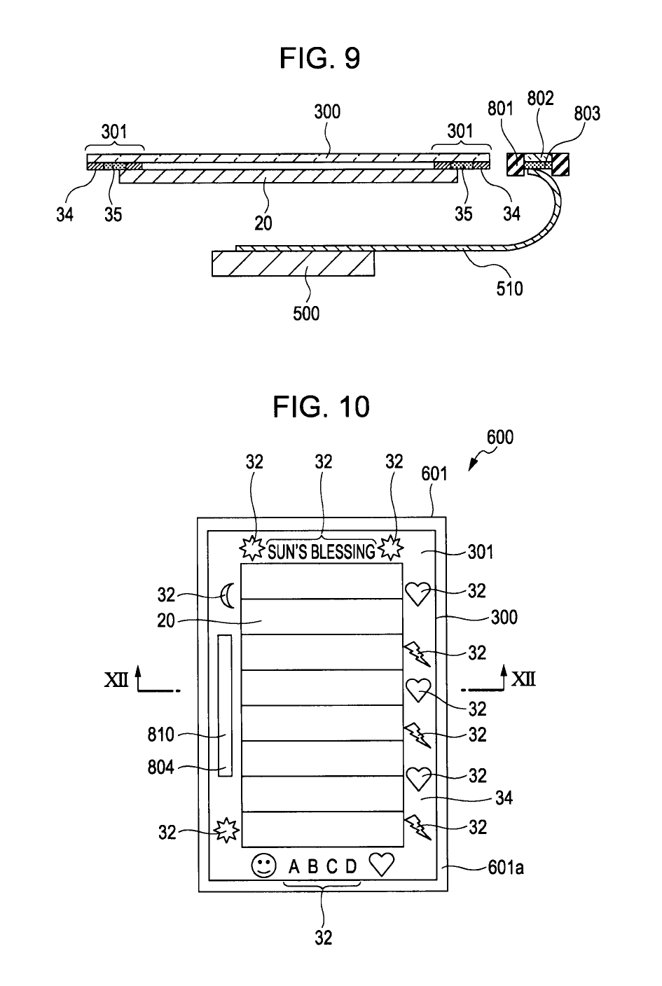

In the portable telephone terminal 60 according to this embodiment, as shown in FIGS. 8 and 9, a heat conductive member, which in this example is a heat conductive sheet 510 is provided so as to connect between the surface of the secondary battery 500 and the thermochromic-paint-applied section 803 on the back surface side of the transparent plate 802. The heat conductive sheet 510 is formed by, for example, a copper foil or graphite-based sheet, and transmits the temperature of the secondary battery 500 to the thermochromic-paint-applied section 803 on the back surface side of the transparent plate 802.

FIG. 8 is a structural view for explaining an example of the heat conductive sheet 510, showing the portion including a part of the casing 61, the secondary battery 500, and the heat conductive sheet. In FIG. 8, the power-generation-environment display sections 32 in the perimeter region portion 301 of the protective plate 300 are not shown. Also, FIG. 9 is a IX-IX cross-sectional view of FIG. 7.

In the second embodiment as well, the user is informed of the amount of light received by the light receiving surface of the solar battery module 20, on the basis of a change in the display color of the power-generation-environment display sections 32 formed by the photochromic-paint-applied sections 35.

In the second embodiment, the temperature of the secondary battery 500 is transmitted to the thermochromic-paint-applied section 803 of the charging environment display section 800 through the heat conductive sheet 510. Therefore, the temperature of the secondary battery 500 is displayed as the display color of the thermochromic-paint-applied section 803 of the charging environment display section 800 on the back surface side of the transparent plate 802.

Since a thermochromic paint develops color at about 40° C. to 50° C., the thermochromic paint changes display color from when the temperature of the secondary battery 500 is equal to or lower than 60° C. that is the critical temperature of the secondary battery 500 at the time of charging, thereby informing the user of the rise in temperature of the secondary battery 500.

That is, when the temperature of the secondary battery 500 rises to about 40° C. to 50° C., the display color of the thermochromic-paint-applied section 803 on the back surface side of the transparent plate 802 of the charging environment display section 800 changes to a specific color in accordance with the temperature, thereby informing the user of the rise in temperature of the secondary battery 500 through the transparent plate 802.

The portable telephone terminal 60 according to the second embodiment has also the same internal electronic circuit configuration as that of the first embodiment shown in FIG. 6, and stops charging when, during charging, the secondary battery 500 is at a high temperature, for example, at 60° C. or above, and its output voltage is high.

According to the second embodiment, by looking at the display color of the thermochromic-paint-applied section 803 of the charging environment display section 800, the user can take appropriate measures for preventing conditions not appropriate for charging, such as stopping charging even in a state when charging has not stopped in the internal electronic circuit of the main body of the portable telephone terminal 60, or moving the portable telephone terminal 60 to an environment that lowers the temperature of the secondary battery 500.

In the case of the second embodiment, the charging environment display section 800 directly displays a temperature change of the secondary battery 500 through a change in the display color of the thermochromic-paint-applied section 803. Therefore, unlike in the case of the first embodiment in which the temperature of the secondary battery 500 is displayed on the LCD screen, there is no power consumption whatsoever, with no wasteful consumption of the precious output electric power of the secondary battery 500.

According to the second embodiment, in the charging environment display section 800, the thermochromic-paint-applied section 803 is surrounded by the heat insulating section 801, thereby ensuring isolation from the heat of the casing 61 of the portable telephone terminal 60, and also the temperature of the secondary battery 500 is transmitted to the thermochromic-paint-applied section 803 through the heat conductive sheet 510. Consequently, the temperature of the secondary battery 500 is transmitted to the thermochromic-paint-applied section 803 substantially accurately, and an indication that the temperature of the secondary battery 500 has become high can be reliably displayed by the charging environment display section 800 formed by the thermochromic-paint-applied section 803.

It suffices for the transparent plate 802 provided on the front surface of the thermochromic-paint-applied section 803 to be transparent, and the transparent plate 802 may not be one having special property such as ultraviolet-transmitting property like the protective plate 300 provided on the front surface portion of the photochromic-paint-applied sections 35.

The thermochromic-paint-applied section 803 can be also changed into a predetermined display color by adding a pigment or the like to thereby enhance the design property of the charging environment display section 800.

In the second embodiment as well, the same modifications as those in the case of the first embodiment can be adopted with respect to the configuration of the power-generation-environment display sections 32 of the protective plate 300, and portions related to the configuration.

### Third Embodiment

A third embodiment concerns an improvement of the second embodiment. In the second embodiment, in the surface 61a of the casing 61 of the portable telephone terminal 60, the charging environment display section 800 is provided in a space different from the space where the solar battery module 20 is provided. This causes an increase in the size of the surface 61a of the casing 61 of the portable telephone terminal 60 in which the solar battery module 20 is provided, leading to a corresponding increase in the size of the casing 61.

The third embodiment provides a portable telephone terminal which allows the charging environment display section to be provided while eliminating as much wasted space as possible.

FIG. 10 shows the outward appearance of a portable telephone terminal 600 as an example of a portable device according to the third embodiment. The portable telephone terminal 600 in this example represents an improvement of the portable telephone terminal 60 according to the second embodiment, and hence its portions that are the same as those of the portable telephone terminal 60 are denoted by the same symbols and detailed description thereof is omitted.

In the portable telephone terminal 600 according to the third embodiment, not only the power-generation-environment display sections 32 but also a charging environment display section 810 is formed in the perimeter region portion 301 of the protective plate 300. That is, of the perimeter region portion 301 of the protective plate 300, the region of a part of the hiding-paint-applied section, a part of the regions used as the power-generation-environment display sections 32, or a region made up of the region of a part of the hiding-paint-applied section and a part of the regions used as the power-generation-environment display sections 32, is allocated as a region for forming the charging environment display section 810.

In the example shown in FIG. 10, the charging environment display section 810 is formed in the left-side perimeter portion of the perimeter region portion 301 of the protective plate 300. The charging environment display section 810 is made of a thermochromic-paint-applied section 804 formed by coating or printing thermochromic paint onto the back surface side of the left-side perimeter portion of the perimeter region portion 301 of the protective plate 300.

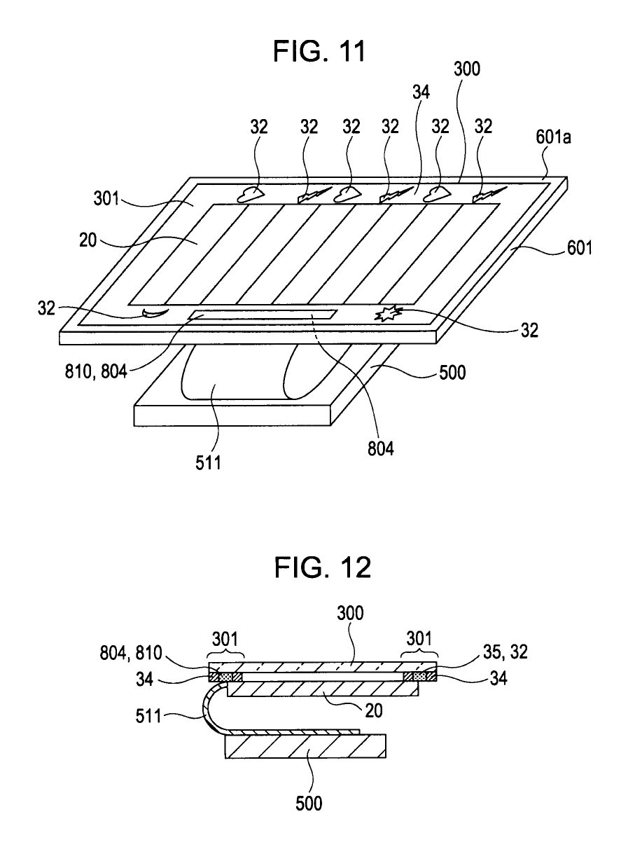

Then, as shown in FIGS. 11 and 12, a heat conductive member, which in this example is a heat conductive sheet 511 is provided so as to serve as a bridge connecting between the surface of the secondary battery 500 and the thermochromic-paint-applied section 804 on the back surface side of the perimeter region portion 301 of the protective plate 300. As in the second embodiment described above, the heat conductive sheet 511 in this example is formed by, for example, a copper foil or graphite-based sheet, and transmits the heat of the secondary battery 500 to the thermochromic-paint-applied section 804 on the back surface side of the perimeter region portion 301 of the protective plate 300.

It should be noted that FIGS. 11 and 12 are structural views for explaining how the temperature of the secondary battery 500 is transmitted to the thermochromic-paint-applied section 804 by the heat conductive sheet 511, and FIG. 12 is an XII-XII cross-sectional view of FIG. 10.

Although not shown in FIG. 12, a heat insulator made of rubber, for example, is inserted between the thermochromic-paint-applied section 804 provided on the back surface side of the perimeter region portion 301 of the protective plate 300, the casing 61, and the perimeter frame section of the solar battery module 20. This heat insulator prevents the thermochromic-paint-applied section 804 from directly contacting the casing 61 and the solar battery module 20.

In a region of the perimeter region portion 301 of the protective plate 300 excluding the left-side perimeter portion, the power-generation-environment display sections 32 formed by the photochromic-paint-applied sections 35 are formed on the back surface side as in the embodiments described above.

In this way, according to the third embodiment, in the perimeter region portion 301 of the protective plate 300, there are formed not only the power-generation-environment display sections 32 but also the charging environment display section 810. The amount of light incident on the light receiving surface of the solar module 20 is indicated by the display color of the photochromic paint of the power-generation-environment display sections 32, and the temperature of the secondary battery 500 is indicated by the display color of the thermochromic paint of the charging environment display section 810.

Therefore, by only looking at the perimeter region portion 301 of the protective plate 300, the user can recognize both the power generation environment in terms of the amount of light incident on the light receiving surface of the solar battery module 20, and the charging environment in terms of the temperature of the secondary battery 500 at the same time.

According to the third embodiment, unlike in the second embodiment, it is unnecessary to provide the charging environment display section in an area separate from the protective plate 300. Thus, the surface 61a of the casing 61 does not become unnecessarily large, allowing the casing 61 to be made compact. Further, the light receiving surface of the solar battery module 20 can be arranged across the entire surface 61a of the casing 61, allowing for high power generation efficiency.

The foregoing description is directed to the case in which the charging environment display section 810 provided in the perimeter region portion 301 of the protective plate 300 is obtained by applying thermochromic paint in the shape of a rectangular region. However, of course, like the power-generation-environment display sections 32, the charging environment display section 810 can be also formed as a design of various shapes, symbols, letters, or the like.

In the third embodiment, the same modifications as those in the first embodiment and the second embodiment can be adopted with respect to the configurations of the power-generation-environment display sections 32 and charging environment display section 810 of the protective plate 300, and portions related to the configurations.

It should be noted that the function of displaying the temperature of the secondary battery, which is the function of the charging environment display section 810, can be applied also to a device that does not have a solar battery module and charges its secondary battery by a commercial AC power supply.

### Fourth Embodiment

In the third embodiment, in the perimeter region portion 301 of the protective plate 300, the power-generation-environment display sections 32 made of photochromic paint and the charging environment display section 810 made of thermochromic paint are formed in different regions. In contrast, in a fourth embodiment, a power generation/charging environment display section integrating the power-generation-environment display sections 32 and the charging environment display section 810 together is formed in the perimeter region portion 301 of the protective plate 300. The power generation/charging environment display section has a function of displaying the amount of received light and the battery temperature.

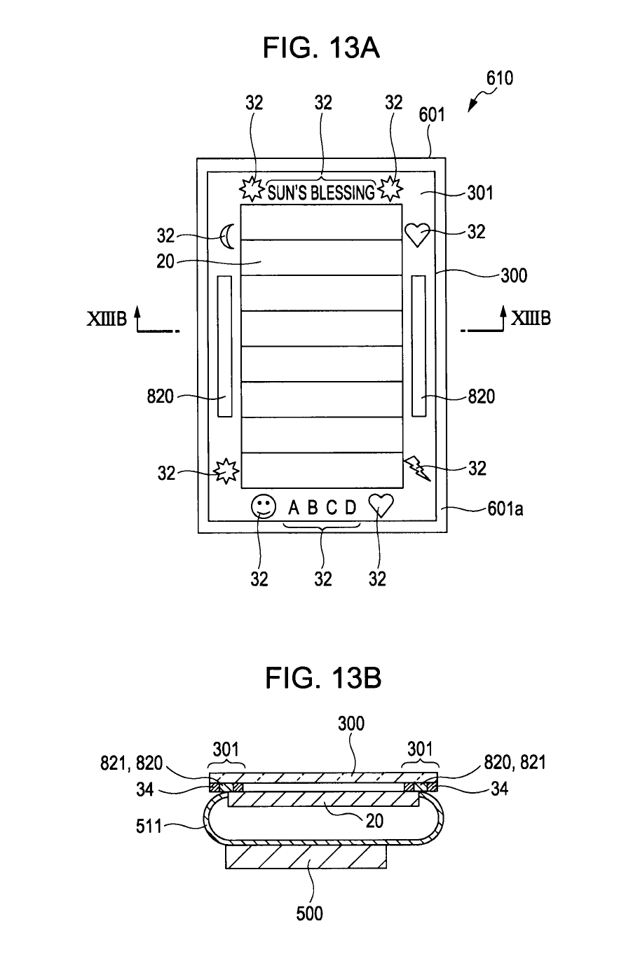

A portable telephone terminal 610 in the example shown in FIGS. 13A and 13B represents a case in which the fourth embodiment is applied to a portable telephone terminal similar to that of the third embodiment described above. Portions that are the same as those of the portable telephone terminal 600 according to the third embodiment are denoted by the same reference numerals, and detailed description thereof is omitted. FIG. 13A is a view of the portable telephone terminal 610 as seen from the side of a surface 601a of a casing 601 in which the solar battery module 20 protected by the protective plate 300 is formed. FIG. 13B is a view showing a part of the XIIIB-XIIIB cross-sectional view of FIG. 13A.

In the portable telephone terminal 610 according to the fourth embodiment, not only the power-generation-environment display sections 32 but also a power generation/charging environment display section 820 is formed in the perimeter region portion 301 of the protective plate 300. In the example in FIGS. 13A and 13B, the power generation/charging environment display section 820 is formed in the left and right-side perimeter region portions of the perimeter region portion 301 of the protective plate 300. That is, of the perimeter region portion 301 of the protective plate 300, the hiding region and the power-generation-environment display sections 32 in each of the left and right-side perimeter region portions are allocated as a region for forming the power generation/charging environment display section 820.

On the back surface side of the perimeter region portion 301 of the protective plate 300, a mixed paint obtained by mixing a photochromic paint and a thermochromic paint together is coated or printed onto the power generation/charging environment display section 820, thereby forming a mixed-paint-applied section 821.

Then, as shown in FIG. 13B, a heat conductive member, which in this example is the heat conductive sheet 511 is provided so as to serve as a bridge between the surface of the secondary battery 500 and the mixed-paint-applied section 821 on the back surface side of the perimeter region portion 301 of the protective plate 300. Consequently, the surface temperature of the secondary battery 500 is transmitted to the mixed-paint-applied section 821 forming the power generation/charging environment display section 820 through the heat conductive sheet 511.

Due to the above configuration, in the power generation/charging environment display section 820, the photochromic paint out of the mixed paint of the mixed-paint-applied section 821 forming the power generation/charging environment display section 820 changes to a display color corresponding to the amount of light passing through the protective plate 300, and the thermochromic paint out of the mixed paint of the mixed-paint-applied section 821 changes to a display color corresponding to the surface temperature of the secondary battery 500 transmitted through the heat conductive sheet 511.

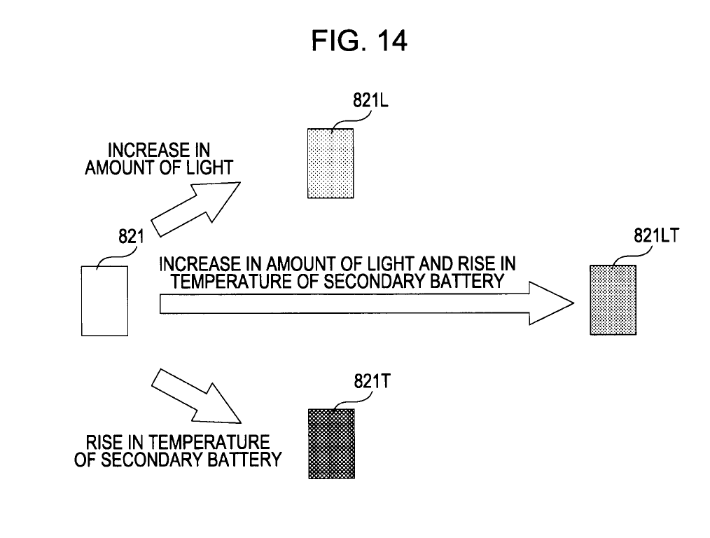

That is, as shown in FIG. 14, when the temperature of the secondary battery 500 is equal to or lower than a predetermined temperature, for example, 40° C., and the amount of light received by the light receiving surface of the solar battery module 20 increases, the mixed-paint-applied section 821 forming the power generation/charging environment display section 820 changes to a predetermined display color (see a mixed-paint-applied section 821L in FIG. 14) corresponding to a change in the display color of the photochromic paint out of the mixed paint.

Also, when the amount of light received by the light receiving surface of the solar battery module 20 is small, and the temperature of the secondary battery 500 becomes equal to or higher than, for example, 40° C., the mixed-paint-applied section 821 forming the power generation/charging environment display section 820 changes to a predetermined display color (see a mixed-paint-applied section 821T in FIG. 14) corresponding to a change in the display color of the thermochromic paint out of the mixed paint.

Then, when the amount of light received by the light receiving surface of the solar battery module 20 increases, and the temperature of the secondary battery 500 becomes equal to or higher than, for example, 40° C., the mixed-paint-applied section 821 forming the power generation/charging environment display section 820 changes to a predetermined display color (see a mixed-paint-applied section 821LT in FIG. 14) that is the mixed color of the changed display color of the photochromic paint and the changed display color of the thermochromic paint.

In this way, the mixed-paint-applied section 821 forming the power generation/charging environment display section 820 changes to a mixed color of the display color of the photochromic paint and the display color of the thermochromic paint. The user is informed of the amount of light incident on the solar battery module 20, and the temperature of the secondary battery 500 at the same time through this display of the mixed color.

For instance, if a blue-based paint is used as the photochromic paint, and a red-bed paint is used as the thermochromic paint, the mixed-paint-applied section 821 of the power generation/charging environment display section 820 changes to the following display color depending on the amount of received light and the temperature of the secondary battery 500.

When the amount of received light is small, and the temperature of the secondary battery 500 is low, the mixed-paint-applied section 821 of the power generation/charging environment display section 820 takes on a white color. Then, when the amount of received light becomes large, and the temperature of the secondary battery 500 does not substantially change, the mixed-paint-applied section 821 of the power generation/charging environment display section 820 takes on a blue color with a darkness corresponding to the amount of received light. Also, when the amount of received light is small but the temperature of the secondary battery 500 becomes high, the mixed-paint-applied section 821 of the power generation/charging environment display section 820 takes on a red color.

Then, when the amount of received light is large, and the temperature of the secondary battery 500 becomes high, the mixed-paint-applied section 821 of the power generation/charging environment display section 820 changes from a blue color to a purple color with a darkness corresponding to the temperature of the secondary battery 500.

Therefore, when the power generation/charging environment display section 820 takes on a red or purple color, the user can learn that the temperature of the secondary battery 500 has risen and the current environment is not appropriate for charging. At this time, if the power generation/charging environment display section 820 takes on a red or purple color with a predetermined darkness, as described above, charging of the secondary battery 500 by the charging circuit is stopped, thereby preventing deterioration of the secondary battery 500.

Then, in this embodiment, the user who has seen the change of the power generation/charging environment display section 820 to a red or purple color can take such measures as moving the portable telephone terminal 610 placed under high temperature environment to a cool place, for example.

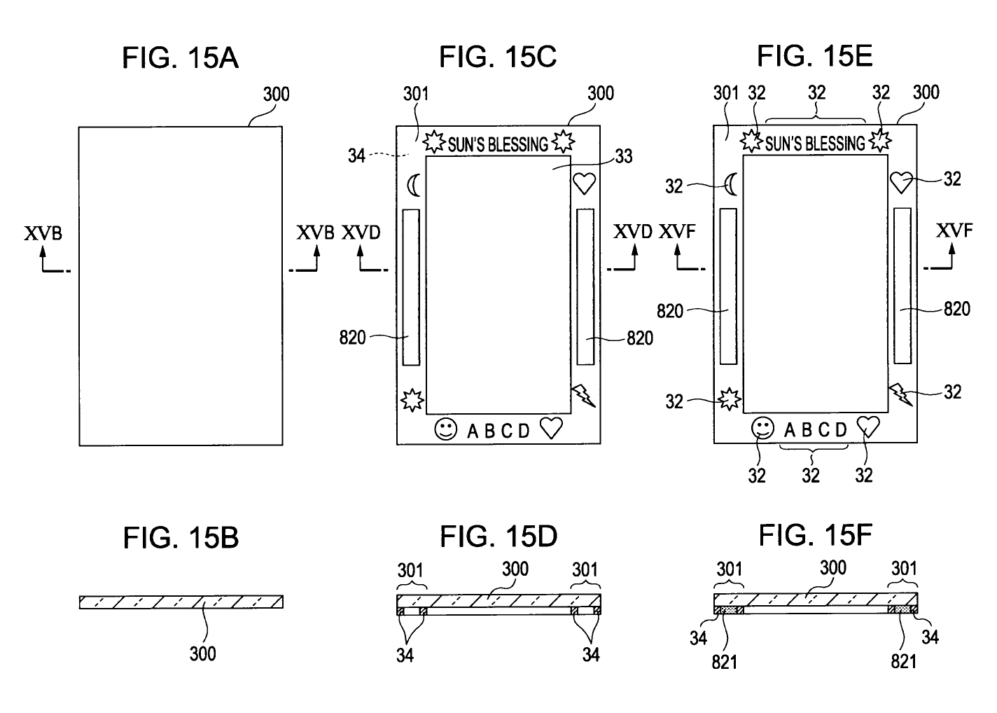

FIGS. 15A to 15F are views for explaining the procedure of forming the perimeter region portion 301 in the protective plate 300.

First, ultraviolet-transmitting resin forming the protective plate 300 is selected. In this example, as in the case of the protective plate 30 according to the first embodiment, Clarex S-0 (product name) manufactured by Kuraray Co., Ltd. is used. FIG. 15A is a plan view of the protective plate 300, and FIG. 15B is an XVB-XVB cross-sectional view of FIG. 15A. As shown in FIGS. 15A and 15B, the protective plate 300 in this example is made up of a single transparent plate of ultraviolet-transmitting resin, including the region that is to become the perimeter region portion 301 described later.

Next, as shown in FIG. 15C and FIG. 15D that is a XVD-XVD cross-sectional view of FIG. 15C, in this case, hiding paint is applied by screen printing to the perimeter region portion 301 of the protective plate 300, except for the regions of the power-generation-environment display sections 32 formed by design display sections formed as designs of symbols, marks, or letters and the region of the power generation/charging environment display section 820, thereby forming the hiding-paint-applied section 34. As the hiding paint, black paint is used in this case. It should be noted that as long as the hiding-paint-applied section 34 can be formed so as to make the perimeter frame section 22 of the solar battery module 20 provided on the back surface side of the protective plate 300 invisible from the outside, the hiding paint is not limited to a black paint, but a paint of any color that can provide opacity may be used.

Next, as shown in FIG. 15E and FIG. 15F that is a XVF-XVF cross-sectional view of FIG. 15E, in the perimeter region portion 301 of the protective plate 300, a mixed paint of photochromic paint and thermochromic paint is applied by screen printing in this example to a region not applied with the hiding paint and where the power generation/charging environment display section 820 is to be formed, thereby forming the power generation/charging environment display section 820. Also, in the perimeter region portion 301 of the protective plate 300, photochromic paint is applied by screen printing in this example to a region not applied with the hiding paint and where the power-generation-environment display sections 32 are to be formed, thereby forming the power-generation-environment display sections 32 formed by the photochromic-paint-applied sections 35.

In this way, in the perimeter region portion 301 of the protective plate 300, a hiding section for the perimeter frame section 22 of the solar battery module 20 is formed by the hiding-paint-applied section 34, the plurality of power-generation-environment display sections 32 formed by the photochromic-paint-applied sections 35 are formed, and also the power generation/charging environment display section 820 formed by the mixed-paint-applied section 821 is formed.

In this embodiment, as shown in FIGS. 13A and 13B, the power-generation-environment display sections 32 are formed in the perimeter region portion 301 of the protective plate 300 together with the power generation/charging environment display section 820, as in the above-described embodiment. Therefore, by seeing both the power generation/charging environment display section 820 and the power-generation-environment display sections 32, the user can grasp the amount of received light and the temperature of the secondary battery 500 at that time.

It should be noted that in the perimeter region portion 301 of the protective plate 300, not only the power-generation-environment display sections 32 but also the charging environment display section 810 may be provided together with the power generation/charging environment display section 820. For example, as in the above-described embodiment, it is also possible to form the power generation/charging environment display section 820 in each of the left and right-side perimeter region portions of the perimeter region portion 301 of the protective plate 300, and form the power-generation-environment display sections 32 at the upper side of the perimeter region portion 301 and form the charging environment display section 810 at the lower side of the perimeter region portion 301.

The above description is directed to the case in which the power generation/charging environment display section 820 provided in the perimeter region portion 301 of the protective plate 300 is obtained by applying thermochromic paint in the shape of a rectangular region. However, of course, like the power-generation-environment display sections 32, the power generation/charging environment display section 820 can be also formed as a design of various shapes, symbols, letters, or the like.

### Fifth Embodiment

In the above embodiments, the power-generation-environment display sections 32, the charging environment display section 810, and the power generation/charging environment display section 820 are provided on the back surface side of the perimeter region portion 31 or 301 of the protective plate 30 or 300.

However, the power-generation-environment display sections 32, the charging environment display section 810, and the power generation/charging environment display section 820 may be provided on the front surface side of the perimeter region portion 31 or 301 of the protective plate 30 or 300. Although paint is exposed to the outside in this case, this may be left as it is. However, to prevent graininess of the surface due to the paint being directly exposed to the outside, and peeling of the paint, it is preferable not to make the paint be directly exposed to the outside.

A fifth embodiment represents an example in which the power-generation-environment display sections, the charging environment display section, or the power generation/charging environment display section is provided on the front surface side of the protective plate, and paint is prevented from being exposed to the outside. As example of the fifth embodiment will be described below, with the case of the protective plate 30 in which only the power-generation-environment display sections 32 are formed in the perimeter region portion 31 taken as an example.

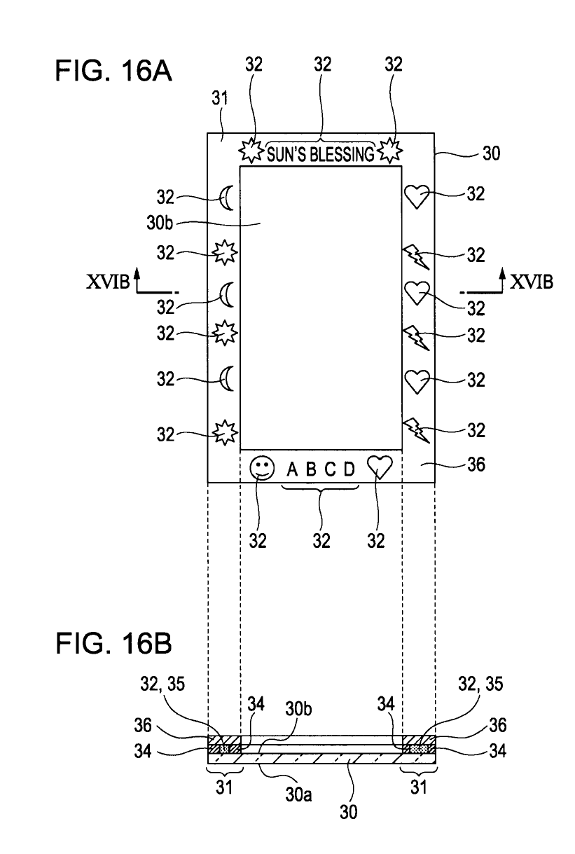

FIGS. 16A and 16B are views showing an exemplary configuration of the protective plate 30 according to the fifth embodiment in that case. FIG. 16A is a plan view of the protective plate 30, and FIG. 16B is a XVIB-XVIB cross-sectional view of FIG. 16A.

In this example, the power-generation-environment display sections 32 formed by the photochromic-paint-applied sections 35 are provided in a region on the front surface 30b side of the protective plate 30 corresponding to the perimeter region portion 31. Then, in the perimeter region portion 31 of the front surface 30b of the protective plate 30, a protective film 36 made of ultraviolet-transmitting resin in this example is provided on the hiding-paint-applied section 34 and the photochromic-paint-applied sections 35.

The procedure of forming the perimeter region portion 31 in the protective plate 30 in the example shown in FIGS. 16A and 16B will be described. First, the material of the protective plate 30 is selected. In this case, it is not necessary for the protective plate 30 to transmit light incident on the photochromic-paint-applied sections 35. Hence, it is not necessary to use ultraviolet-transmitting resin for the protective plate 30 in this case, and the protective plate 30 can be made of acrylic resin, polycarbonate, or blue sheet glass.

Next, the hiding-paint-applied section 34 is applied to the perimeter region portion 31 of the front surface 30b of the protective plate 30 by coating, screen printing, or the like of hiding paint, except for the regions of the power-generation-environment display sections 32 formed by design display sections formed as designs of symbols, marks, or letters.

Next, in the perimeter region portion 31 of the front surface 30b of the protective plate 30, photochromic paint is applied by screen printing in this example to a region not applied with the hiding paint and where the power-generation-environment display sections 32 are to be formed, thereby forming the power-generation-environment display sections 32 formed by the photochromic-paint-applied sections 35.

Next, the protective film 36 made of ultraviolet-transmitting resin is formed on the hiding-paint-applied section 34 and the power-generation-environment display sections 32 formed by the photochromic-paint-applied sections 35 which are formed in the perimeter region portion 31 of the front surface 30b of the protective plate 30. As the protective film 36 in this case, for example, Clarex S-0 (product name) manufactured by Kuraray Co., Ltd. is used.

The protective plate 30 with the power-generation-environment display sections 32 formed in the perimeter region portion 31 in this way is used as a protective plate for the solar battery module 20 as in the first embodiment.

While the above example is directed to the case of the protective plate 30 with the power-generation-environment display sections 32 formed in the perimeter region portion 31, of course, the protective plate 300 with the charging environment display section 810 or the power generation/charging environment display section 820 formed in the perimeter region portion 301 can be configured in the same manner as described above.

### Sixth Embodiment

In the first, third, fourth, and fifth embodiments described above, the power-generation-environment display sections 32, the charging environment display section 810, and the power generation/charging environment display section 820 are provided in the perimeter region portion 31 or 301 of the protective plate 30 or 300.

Incidentally, as described above with reference to FIGS. 2A and 2B in the first embodiment, the solar battery module 20 is made up of a plurality of solar cells connected in series. The respective light receiving surfaces of the plurality of solar cells are so provided as to be capable of receiving incident light through the protective plate 30. Further, as shown in FIGS. 2A and 2B, the light receiving surface 20a of the solar battery module 20 is made up of a set of the respective light receiving surfaces of the plurality of solar cells, for example, the eight solar cells 21a, 21b, 21c, . . . , 21h, and the seal sections 23 not contributing to photoelectric conversion are created between the solar cells.

According to a sixth embodiment, the power-generation-environment display sections 32, the charging environment display section 810, or the power generation/charging environment display section 820 is formed not in the perimeter region portion 31 or 301 of the protective plate 30 or 300 but in the seal sections 23 of the solar battery module 20.

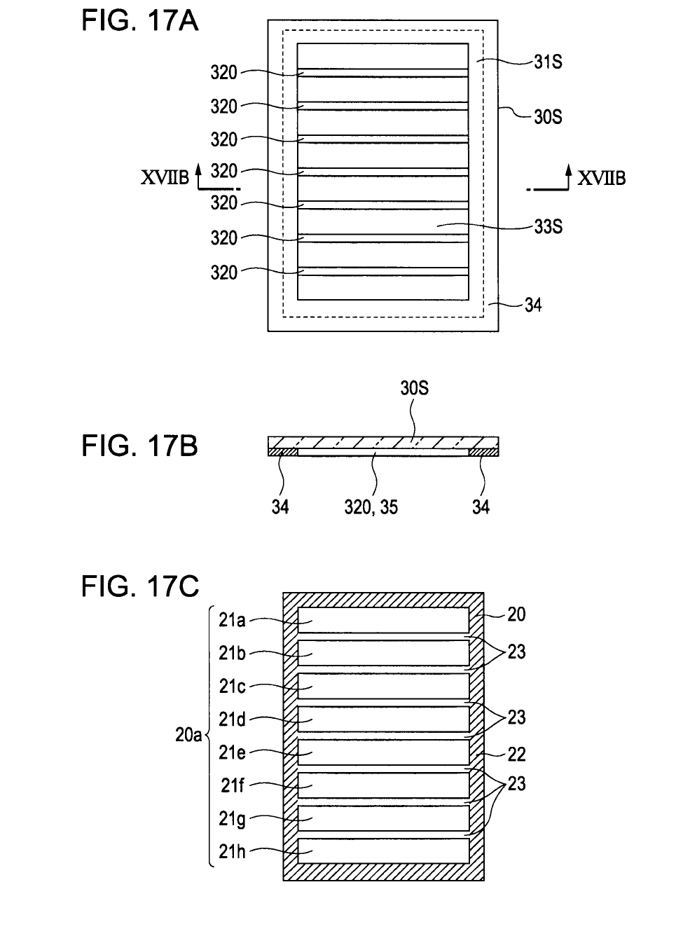

FIGS. 17A to 17C are views for explaining a protective plate as the main portion of the sixth embodiment, and a solar battery module. FIG. 17A is a plan view of a protective plate 30S according to the sixth embodiment, and FIG. 17B is a XVIIB-XVIIB cross-sectional view of FIG. 17A. Also, FIG. 17C shows an exemplary configuration of the solar battery module 20 according to the sixth embodiment, which is the same as that shown in FIG. 2B according to the first embodiment.

Also, in the same manner as described above, a perimeter region portion 31S of the protective plate 30S serves as a region that hides the perimeter frame section 22 of the solar module 20 when the protective plate 30S is placed on the solar battery module 20.

In the sixth embodiment, the power-generation-environment display sections, the charging environment display section, or the power generation/charging environment display section is not provided in the perimeter region portion 31S of the protective plate 30S. The entire perimeter region portion 31S serves as the hiding-paint-applied section 34 to which hiding paint is applied by coating, screen printing, or the like.

Then, in the sixth embodiment, in a central region portion 33S of the protective plate 30S, power-generation-environment display sections 320 are provided in this example at positions corresponding to the seal sections 23 between the plurality of solar cells 21a, 21b, 21c, . . . , 21h when the protective plate 30S is placed on the solar battery module 20. That is, on the back surface side of the central region portion 33S of the protective plate 30S, the photochromic-paint-applied sections 35 applied with photochromic paint by coating, screen printing, or the like are formed at positions corresponding to the seal sections 23 of the solar battery module 20.

Since the power-generation-environment display sections 320 are provided on the back surface side of the protective plate 30S in this example, it is necessary to use ultraviolet-transmitting resin for the protective plate 30S. However, by applying the fifth embodiment described above to the sixth embodiment, it is also possible to form the protective plate 30S by acrylic resin, polycarbonate, or blue sheet glass other than ultraviolet-transmitting resin, and make at least the incident light on the seal sections 23 to go through an ultraviolet-transmitting resin film. In that case, the ultraviolet-transmitting resin film may be provided so as to cover a region slightly larger than the region of each of the power-generation-environment display sections 320 provided in the linear seal sections 23, or the ultraviolet-transmitting resin film may be attached to the entire region of the light receiving surface 20a of the solar battery module 20.

In the sixth embodiment as well, as in the above-described example, the power-generation-environment display sections 320 take on a display color corresponding to the amount of incident light, thereby making it possible to inform the user of the amount of light incident on the solar battery module 20.

In the sixth embodiment as well, since the power generation environment can be displayed by making effective use of a region of the solar battery module 20 which does not contribute to photoelectric conversion, the space allocated to the light receiving surface of the solar battery module 20 is not reduced, thus making it possible to avoid a situation where the amount of power generation decreases.

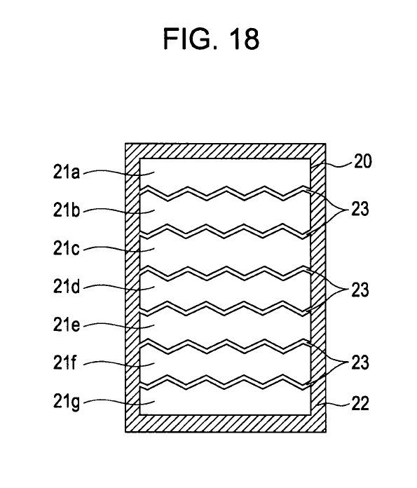

It should be noted that the shape of the seal sections between the plurality of solar cells of the solar battery module 20 is not limited to the linear one shown in FIGS. 17A to 17C but may be, for example, a zig-zag one as shown in FIG. 18, in which case the power-generation-environment display sections 320 provided in the protective plate 30S are formed in conformity to that shape of the seal sections.

While the sixth embodiment is directed to the case in which the power-generation-environment display sections are provided in the protective plate, a charging environment display section made of thermochromic paint may be provided in each of the seal sections 23 instead of the power-generation-environment display sections 320. Also, a part of the seal sections 23 may serve as the power-generation-environment display sections 320, and the other part of the seal sections may serve as a charging environment display section.

Further, a power generation/charging environment display section made of the mixed paint of photochromic paint and thermochromic paint may be provided instead of all or part of the plurality of seal sections 23. In that case, a charging environment display section may be also provided instead of part of the charging environment display sections 320.

While in the above example the entire perimeter region portion 31 is the hiding-paint-applied section 34, as in the examples described above, the power-generation-environment display sections, the charging environment display section, or the power generation/charging environment display section may be provided also in the perimeter region portion 31.

Also, for example, the power-generation-environment display sections, the charging environment display section, and the power generation/charging environment display section may be provided separately in the perimeter region portion 31 and the seal sections 23, in such a way that the charging environment display section is provided in the perimeter region portion 31, and the power-generation-environment display sections are provided in the seal sections 23.

It should be noted that in the same manner as in the second, third, and fourth embodiments, the temperature of the secondary battery is transmitted to the charging environment display section or the power generation/charging environment display section through a heat conductive member such as a heat conductive sheet.

While the above-described example is directed to the case in which the seal sections between the solar cells are used as portions of the solar battery not contributing to photoelectric conversion, the portion above the current-collecting metal wire of the solar battery module or the like can be used as well.

### Seventh Embodiment

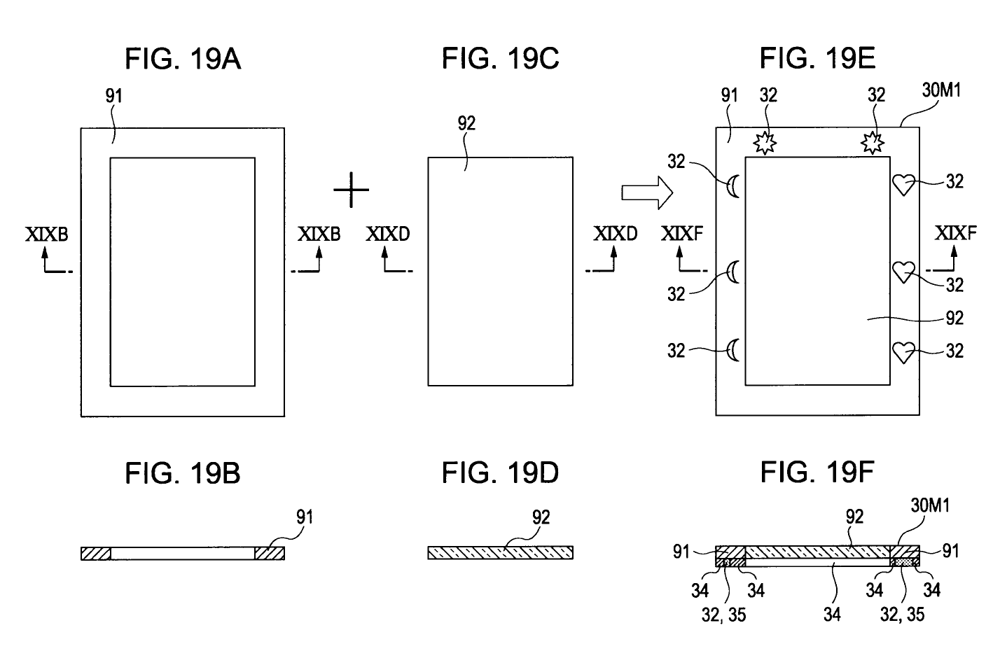

In the first to fourth embodiments described above, a single plate of ultraviolet-transmitting resin is used as the protective plate 30, 300. However, in cases where there is a fear of deterioration of the solar battery module 20 due to incidence of ultraviolet rays, only its perimeter region portion may be made of ultraviolet-transmitting resin. FIGS. 19A to 19F are views for explaining an exemplary configuration of a protective plate 30M1 according to a first example in that case.

The protective plate 30M1 according to the first example is a combination of a frame-shaped plate-like member 91 (see FIGS. 19A and 19B) having the shape of a transparent frame corresponding to the perimeter region portion of the protective plate 30M1, and a rectangular transparent plate 92 (see FIGS. 19C and 19D) having a rectangular shape corresponding to the central portion surrounded by the perimeter region portion.

The frame-shaped plate-like member 91 is formed as a transparent plate made of ultraviolet-transmitting resin made of the Clarex S-0 (product name) manufactured by Kuraray Co., Ltd. described above, for example. Also, the rectangular transparent plate 92 is formed as a transparent plate made of blue sheet glass or polycarbonate that transmits a small amount of ultraviolet rays, or acrylic resin that transmits hardly any ultraviolet rays.

The protective plate 30M1 is formed as a single plate-like member with the rectangular transparent plate 92 fitted inside the hollow at the center of the frame-shaped plate-like member 91. Then, in the example shown in FIGS. 19A to 19F, the hiding-paint-applied section 34, and the photochromic-paint-applied sections 35 forming the power-generation-environment display sections 32 are formed on the back surface side of the plate-like member 91.

In the example shown in FIGS. 19A to 19F, the rectangular transparent plate 92 can be made to transmit only a small amount of ultraviolet rays, or to transmit hardly any ultraviolet rays, thereby making it possible to mitigate deterioration of the solar battery module 20.

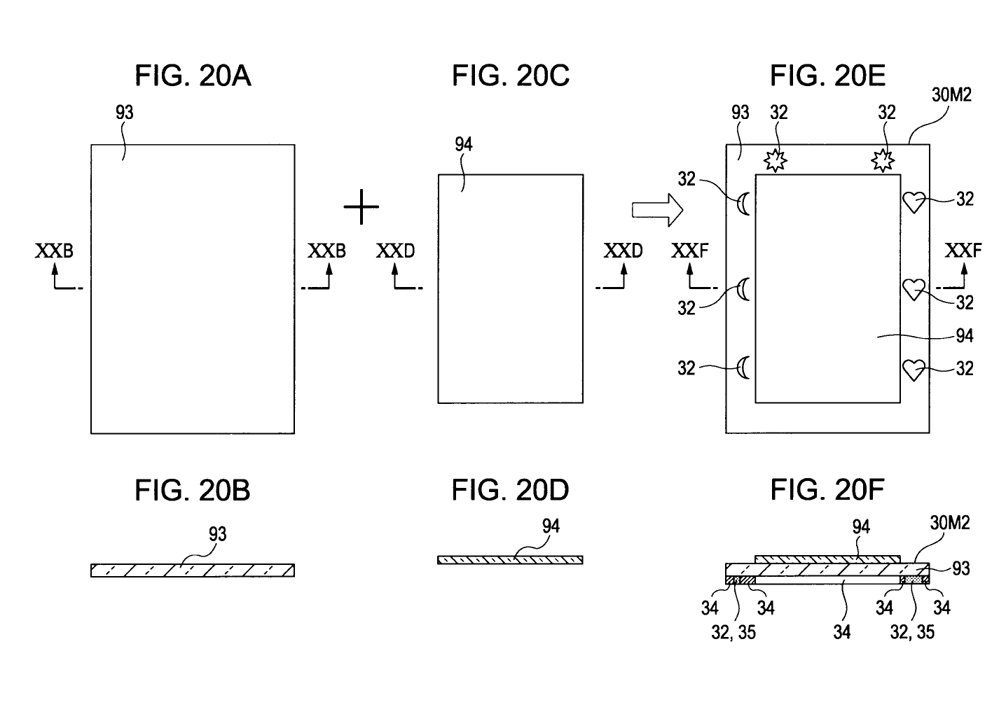

Next, FIGS. 20A to 20F show an exemplary configuration of a protective plate 30M2 according to a second example for preventing deterioration of the solar battery module 20 due to incidence of ultraviolet rays.

The protective plate 30M2 according to the second example is formed by sticking an ultraviolet-cutting film 94 (see FIGS. 20C and 20D) onto a rectangular transparent plate 93 (see FIGS. 20A and 20B) that is made of ultraviolet-transmitting resin as in the first to fourth embodiments described above. The ultraviolet-cutting film 94 is stuck to the central region portion 33S of the protective plate 30S to which the light receiving surface 20a of the solar battery module 20 corresponds when the protective plate 30S is placed on the solar battery module 20.

FIG. 20A is a plan view of the rectangular transparent plate 93, and FIG. 20B is a XXB-XXB cross-sectional view of FIG. 20A. FIG. 20C is a plan view of the ultraviolet-cutting film 94, and FIG. 20D is a XXD-XXD cross-sectional view of FIG. 20C. Further, FIG. 20E is a plan view of the protective plate 30M2 formed by sticking the ultraviolet-cutting film 94 onto the rectangular transparent plate 93, and FIG. 20F is an XXF-XXF cross-sectional view of FIG. 20E.

### Other Embodiments and Modifications

In the second to fourth embodiments described above, a heat conductive sheet is used to transmit the surface temperature of the secondary battery 500 to the thermochromic paint or mixed paint forming the charging environment display section 810 or the power generation/charging environment display section 820. However, means for effecting conduction of the heat of the secondary battery 500 to the thermochromic-paint-applied section or mixed-paint-applied section is not limited to a heat conductive sheet.

For example, if the distance between the secondary battery 500 and the thermochromic-paint-applied section or the mixed-paint-applied section is short, a metal with high heat conductivity such as copper or aluminum may be provided between the secondary battery 500 and the thermochromic-paint-applied section or the mixed-paint-applied section.

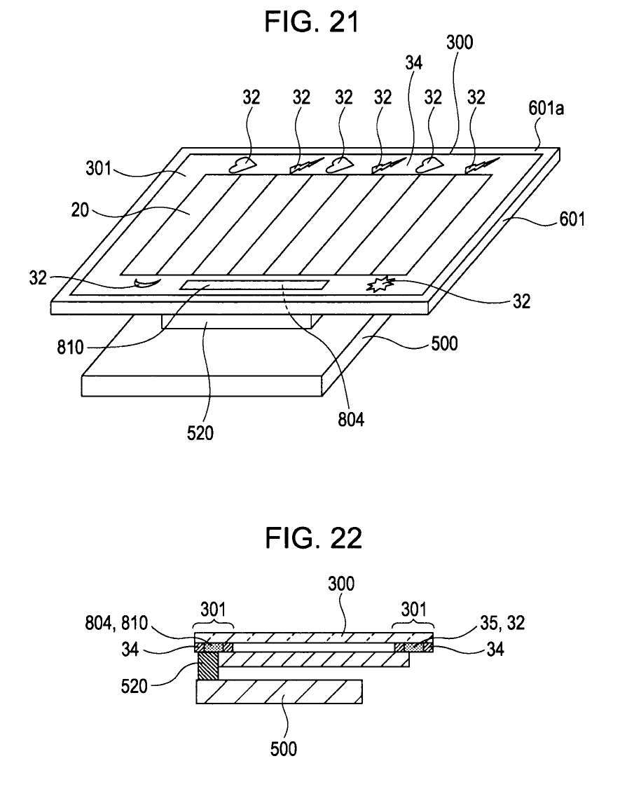

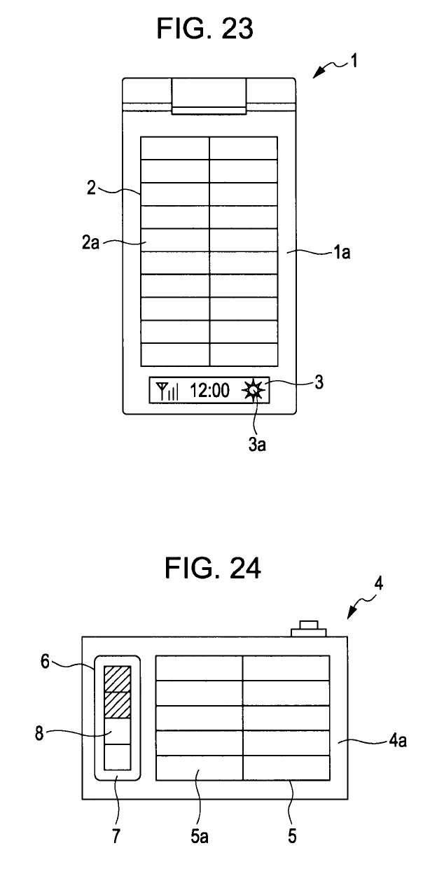

FIGS. 21 and 22 are views showing an example in which, in the third embodiment described above with reference to FIGS. 11 and 12, for example, a heat conductive block 520 formed by a metal block of copper or aluminum is used instead of the heat conductive sheet 511. FIG. 21 is a view corresponding to FIG. 11, and FIG. 22 is a view corresponding to FIG. 12.

In this example, the heat conductive block 520 is provided between the secondary battery 500 and the thermochromic-paint-applied section 804.

While in the above embodiments the protective plate is provided mainly for protecting the light receiving surface of the solar battery module, the protective plate may be one that protects not only the solar battery module but also other portions, for example, the entire surface of the casing to which the solar battery module 20 is provided.

As the solar battery module 20 according to the above-described embodiments, a dye-sensitized solar battery module that exhibits high design property in terms of coloring can be used as well. The use of a dye-sensitized solar battery module as the solar battery module 20 has an advantage in that it is possible to provide a portable device with its colorful image enhanced when used in combination with the power-generation-environment display sections 32, the charging environment display section 810, and the power generation/charging environment display section 820 which are formed as designs provided in the perimeter region portion 31 of the protective plate 30.

While the above embodiments are all directed to the case in which the present invention is applied to a portable telephone terminal, as described above, the present invention can be also applied to portable devices other than a portable telephone terminal. For example, the present invention can be also applied to a charger for a portable device such as a portable telephone terminal using a solar battery module.

Moreover, according to an embodiment of the present invention, the photoelectric conversion section for converting light into electric power is not limited to a solar battery module.

It should be understood by those skilled in the art that various modifications, combinations, sub-combinations and alterations may occur depending on design requirements and other factors insofar as they are within the scope of the appended claims or the equivalents thereof.

What is claimed is:

1. A portable device comprising:
a casing;
photoelectric conversion section configured to convert light into electric power, and including a light-receiving surface provided on a first surface side of the casing;
a protective plate having light-transmitting property and configured to protect the light-receiving surface of the photoelectric conversion section, the protective plate being provided on the first surface side of the casing; and
an amount-of-received-light display section provided in a perimeter region of the protective plate, the amount-of-received-light display section made of a first paint configured to change display color based on an amount of received light.

2. The portable device according to claim 1, wherein:
the first paint is applied to a side opposite to a light incidence surface of the protective plate, and is configured to change display color based on an amount of ultraviolet, and
at least the perimeter region of the protective plate applied with the first paint is made of a material that transmits ultraviolet rays.

3. The portable device according to claim 1, wherein:
the first paint is applied to a light incidence surface side of the protective plate, and is configured to change display color based on an amount of ultraviolet rays, and
at least the perimeter region of the protective plate applied with the first paint is formed by a member configured to transmit ultraviolet rays.

4. The portable device according to claim 1, wherein the first paint is applied to have a predetermined design.

5. The portable device according to claim 1, further comprising:
a secondary battery configured to be charged by the electric power of the photoelectric conversion section;
a battery temperature display section provided on the first surface side of the casing and made of a second paint configured to change display color based on temperature; and
a temperature transmitting section configured to transmit a temperature of the secondary battery to the second paint.

6. The portable device according to claim 5, wherein the battery temperature display section is provided in the perimeter region of the protective plate.

7. A portable device comprising:
a casing;
photoelectric conversion section configured to convert light into electric power, the photoelectric conversion section including a light-receiving surface provided on a first surface side of the casing;
a protective plate having light-transmitting property and configured to protect the light-receiving surface of the photoelectric conversion section;
a display section provided in a perimeter region of the protective plate and formed by a mixture of a first paint configured to change display color based on an amount of received light and a second paint configured to change display color in accordance with temperature;
a secondary battery configured to be charged by the electric power of the photoelectric conversion section; and
a temperature transmitting section configured to transmit a temperature of the secondary battery to the display section.

8. A portable device comprising:
a casing;
photoelectric conversion section including a plurality of photoelectric conversion cells configured to convert light into electric power, each of the plurality of photoelectric conversion cells having light receiving surfaces provided on a first surface side of the casing;
a protective plate having light-transmitting property and configured to protect the light receiving surfaces of the photoelectric conversion cells; and
a power-generation-environment display section provided in a portion of the protective plate corresponding to a portion other than the light receiving surfaces of the plurality of photoelectric conversion cells and where no photoelectric conversion action takes place, and the power-generation-environment display section being made of a first paint that configured to change display color based on an amount of received light.

9. The portable device according to claim 8, wherein:
the first paint is applied to a side opposite to a light incidence surface of the protective plate, and is configured to change display color based on an amount of ultraviolet rays, and
at least a portion of the protective plate applied with the first paint is made of a material configured to transmit ultraviolet rays.

10. The portable device according to claim 8, wherein:
the first paint is applied to a light incidence surface side of the protective plate, and is configured to change display color based on an amount of ultraviolet rays, and
at least a portion of the protective plate applied with the first paint is formed by a member configured to transmit ultraviolet rays.

11. The portable device according to claim 8, wherein the portion other than the light receiving surfaces of the plurality of photoelectric conversion cells and where no photoelectric conversion action takes place is a portion between light receiving surfaces of adjacent ones of the photoelectric conversion cells.

12. The portable device according to claim 8, further comprising:
a secondary battery configured to be charged by the electric power of the photoelectric conversion section;
a battery temperature display section provided on the first surface side of the casing and made of a second paint configured to change display color based on temperature; and
a temperature transmitting section configured to transmit a temperature of the secondary battery to the second paint.

13. The portable device according to claim 12, wherein the battery temperature display section is also provided in the portion of the protective plate corresponding to the portion other than the light receiving surfaces of the plurality of photoelectric conversion cells and where no photoelectric conversion action takes place.

14. A portable device comprising:
a casing;
photoelectric conversion section including a plurality of photoelectric conversion cells configured to convert light into electric power, each of the plurality of photoelectric conversion cells having light receiving surfaces provided on a first surface side of the casing;
a protective plate having light-transmitting property and configured to protect the light receiving surfaces of the photoelectric conversion;
a display section provided in a portion of the protective plate corresponding to a portion other than the light receiving surfaces of the plurality of photoelectric conversion cells and where no photoelectric conversion action takes place, the display section formed by a mixture of a first paint configured to change display color in accordance with an amount of received light and a second paint configured to change display color in accordance with temperature;
a secondary battery configured to be charged by the electric power of the photoelectric conversion section; and
a temperature transmitting section configured to transmit a temperature of the secondary battery to the display section.

15. A portable device comprising:
a casing;
means for converting light into electric power, the means for converting including a light-receiving surface provided on one a first surface side of the casing;
means for protecting the light receiving surface of the means for converting; and
an amount-of-received-light display section provided in a perimeter region of the means for protecting and made of a first paint that changes display color based on an amount of received light.

16. A portable device comprising:
a casing;
means for converting light into electric power, the means for converting including a light-receiving surface provided on a first surface side of the casing;
means for protecting the light-receiving surface of the means for converting;
a display section provided in a perimeter region of the means for protecting which hides a surrounding portion of the light receiving surface of the means for converting, the display section formed by a mixture of a first paint configured to change a display color based on an amount of received light and a second paint configured to change a display color based on temperature;
a secondary battery provided configured to be charged by the electric power of the means for converting; and
means for transmitting a temperature of the secondary battery to the display section.

17. A portable device comprising:
a casing;
means for converting light into electric power, the means for converting including a plurality of photoelectric conversion cells each having a light-receiving surface provided on a first surface side of the casing;
means for protecting the light receiving surfaces of the means for converting; and
a power-generation-environment display section provided in a portion of the means for protecting at a portion other than the light receiving surfaces of the plurality of photoelectric conversion cells and where no photoelectric conversion action takes place, the power-generation-environment display section made of a first paint configured to change display color based on an amount of received light.

18. A portable device comprising:
a casing;
means for converting light into electric power, the means for converting including a plurality of photoelectric conversion cells each having a light-receiving surface provided on a first surface side of the casing;
means for protecting the light receiving surfaces of the photoelectric conversion;
a display section provided in a portion of the means for protecting corresponding to a portion other than the light receiving surfaces of the plurality of photoelectric conversion cells and where no photoelectric conversion action takes place, the display section formed by a mixture of a first paint configured to change display color based on an amount of received light and a second paint configured to change display color based on temperature;
a secondary battery configured to be charged by the electric power of the means for converting; and
means for transmitting a temperature of the secondary battery to the display section.
